(19) United States
(12) Patent Application Publication
(10) Pub. No.: US 2017/0163732 A1
(43) Pub. Date: Jun. 8, 2017

(54) INTER-TASK COMMUNICATION WITHIN APPLICATION-RELEASE-MANAGEMENT PIPELINES

(71) Applicant: VMWARE, INC., Palo Alto, CA (US)

(72) Inventors: RISHI SARAF, Bangalore (IN); Vishal Jain, Bangalore (IN); Agila Govindaraju, Bangalore (IN)

(21) Appl. No.: 15/017,677

(22) Filed: Feb. 8, 2016

(30) Foreign Application Priority Data
Dec. 4, 2015 (IN) 6507/CHE/2015

(51) Int. Cl. H04L 29/08; H04L 12/911

(52) U.S. Cl. CPC H04L 67/1097; H04L 47/783

(57) ABSTRACT

The current document is directed to an automated-application-release-management controller within an automated-application-release-management subsystem of a workflow-based cloud-management system that provides mechanisms for parameter-value exchanges between tasks of an application-release-management pipeline. Pipeline parameters and task-output parameters are stored in the execution context of the automated-application-release-management controller. During configuration of an automated-application-release-management pipeline, inputs to tasks may be specified as outputs from other tasks. When tasks finish executing, the output values are stored in the execution context of the management controller so that, when execution of subsequent tasks is launched, the stored output values from previously executed tasks can be furnished as input values to the subsequently executed tasks. In addition, pipeline parameters can be defined and initialized in advance of pipeline execution, with the values of pipeline parameters retrieved and/or set during task execution.

### RELATED APPLICTIONS

Benefit is claimed under 35 U.S.C. 119(a)-(d) to Foreign application Serial No. 6507/CHE/2015 filed in India entitled “INTER-TASK COMMUNICATION WITHIN APPLICATION-RELEASE-MANAGEMENT PIPELINES”, filed on Dec. 4, 2015, by VMware, Inc., which is herein incorporated in its entirety by reference for all purposes.

### TECHNICAL FIELD

The current document is directed to automated-application-release-management subsystems within workflow-based cloud-management systems and, in particular, to an automated-application-release-management controller that provides parameter-value exchange between different tasks within an application-release-management pipeline.

### BACKGROUND

Early computer systems were generally large, single-processor systems that sequentially executed jobs encoded on huge decks of Hollerith cards. Over time, the parallel evolution of computer hardware and software produced main-frame computers and minicomputers with multi-tasking operation systems, increasingly capable personal computers, workstations, and servers, and, in the current environment, multi-processor mobile computing devices, personal computers, and servers interconnected through global networking and communications systems with one another and with massive virtual data centers and virtualized cloud-computing facilities. This rapid evolution of computer systems has been accompanied with greatly expanded needs for computer-system management and administration. Currently, these needs have begun to be addressed by highly capable automated management and administration tools and facilities. As with many other types of computational systems and facilities, from operating systems to applications, many different types of automated administration and management facilities have emerged, providing many different products with overlapping functionalities, but each also providing unique functionalities and capabilities. Owners, managers, and users of large-scale computer systems continue to seek methods and technologies to provide efficient and cost-effective management and administration of cloud-computing facilities and other large-scale computer systems.

### SUMMARY

The current document is directed to an automated-application-release-management controller within an automated-application-release-management subsystem of a workflow-based cloud-management system that provides mechanisms for parameter-value exchanges between tasks of an application-release-management pipeline. Pipeline parameters and task-output parameters are stored in the execution context of the automated-application-release-management controller. During configuration of an automated-application-release-management pipeline, inputs to tasks may be specified as outputs from other tasks. When tasks finish executing, the output values are stored in the execution context of the management controller so that, when execution of subsequent tasks is launched, the stored output values from previously executed tasks can be furnished as input values to the subsequently executed tasks. In addition, pipeline parameters can be defined and initialized in advance of pipeline execution, with the values of pipeline parameters retrieved and/or set during task execution.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 shows a workflow-based cloud-management facility that has been developed to provide a powerful administrative and development interface to multiple multi-tenant cloud-computing facilities.

FIG. 12 provides an architectural diagram of the workflow-execution engine and development environment.

FIGS. 13A-C illustrate the structure of a workflow.

FIGS. 14A-B include a table of different types of elements that may be included in a workflow.

FIGS. 15A-B show an example workflow.

FIGS. 16A-C illustrate an example implementation and configuration of virtual appliances within a cloud-computing facility that implement the workflow-based management and administration facilities of the above-described WFMAD.

FIGS. 16D-F illustrate the logical organization of users and user roles with respect to the infrastructure-management-and-administration facility of the WFMAD.

FIG. 17 illustrates the logical components of the infrastructure-management-and-administration facility of the WFMAD.

FIGS. 18-20B provide a high-level illustration of the architecture and operation of the automated-application-release-management facility of the WFMAD.

FIGS. 21A-E illustrate task execution controlled by an automated-application-release-management controller, subsequently referred to as a “management controller” in this document.

FIGS. 22A-F illustrate the management controller to which the current document is directed.

FIGS. 23A-E illustrate an example parameter, parameter-specifying subexpressions, and example specification of inter-task parameter-value exchange via the graphical user interface provided by the automated-application-release-management subsystem containing the currently disclosed management controller.

FIGS. 24A-D provide extracts of control-flow diagrams to indicate how, in one implementation, the management controller provides for inter-task information exchange.

### DETAILED DESCRIPTION OF EMBODIMENTS

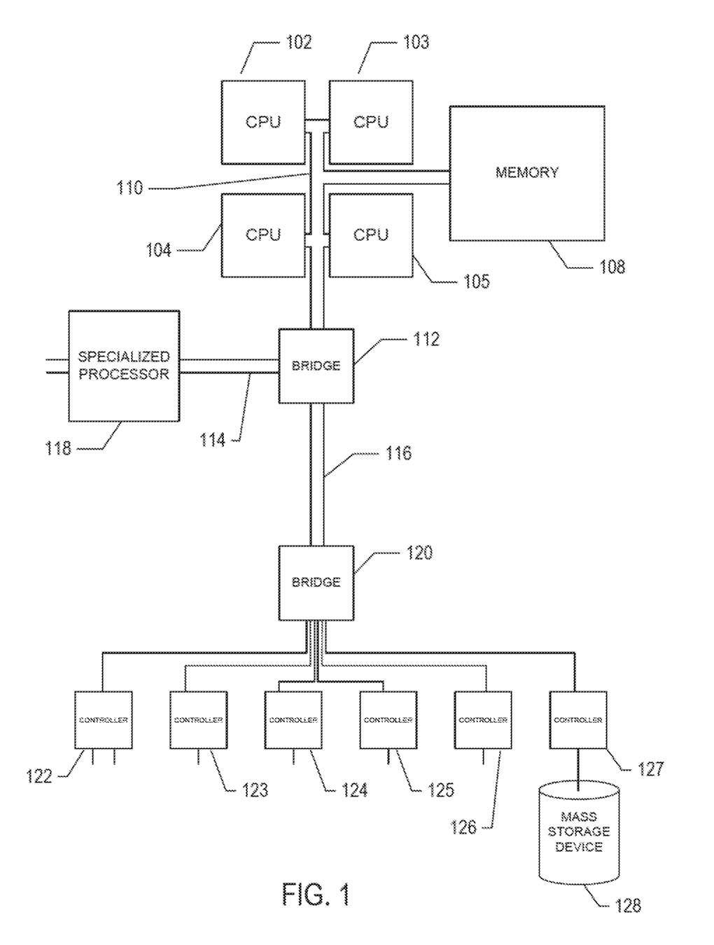

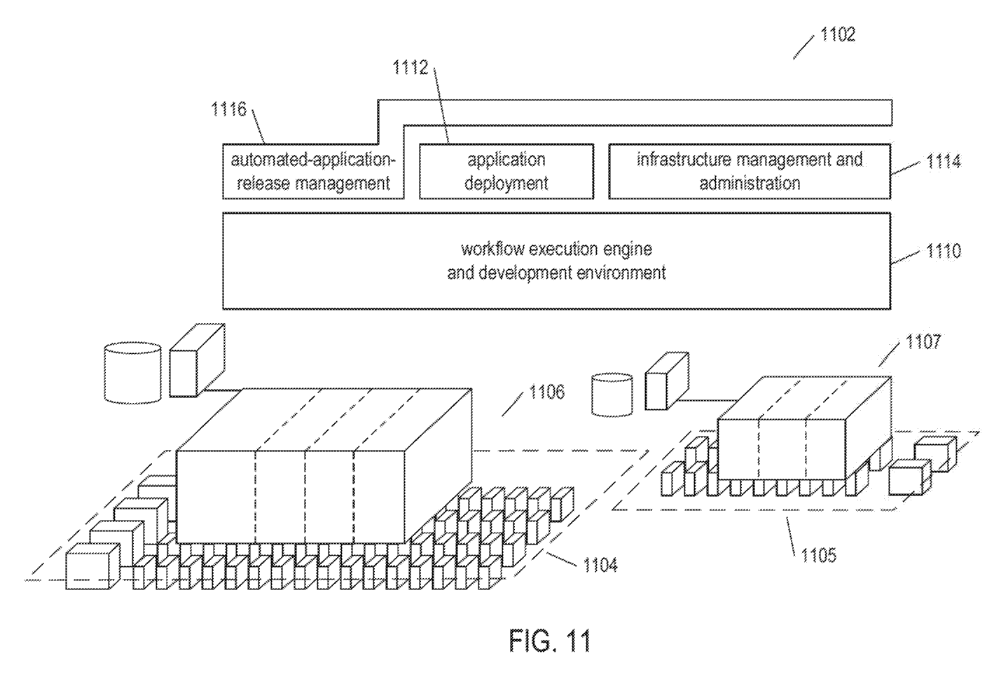

The current document is directed to exchange of parameter values between tasks of an application-release-management pipeline. In a first subsection, below, a detailed description of computer hardware, complex computational systems, and virtualization is provided with reference to FIGS. 1-10. In a second subsection, an overview of a workflow-based cloud-management facility is provided with reference to FIGS. 11-20B. In a third subsection, implementations of the currently disclosed automated-application-release-management controller that provides for parameter-value exchange between executing tasks are discussed.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

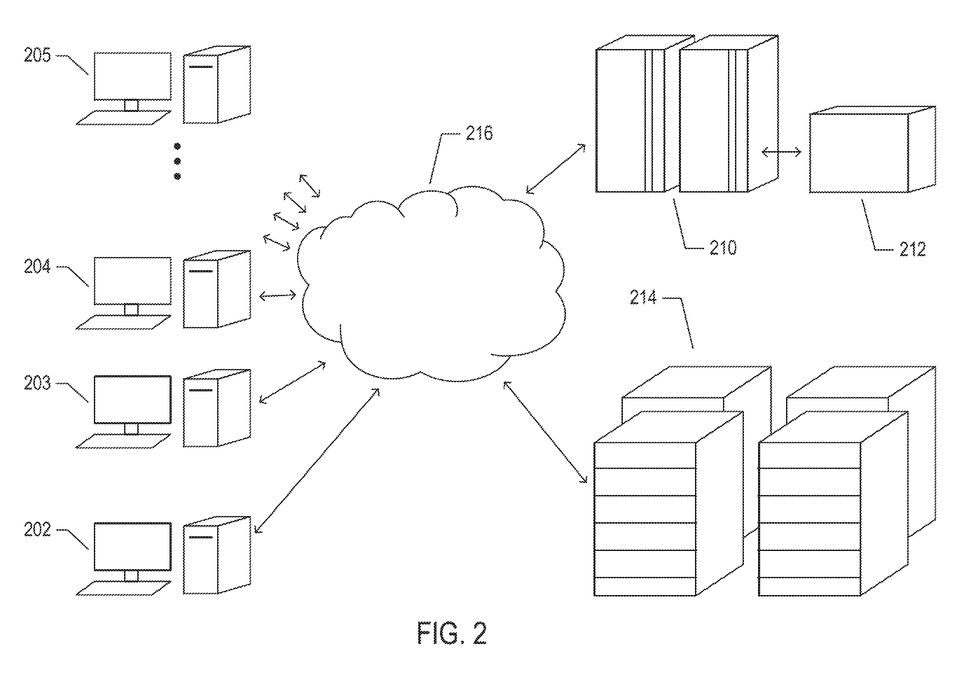

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

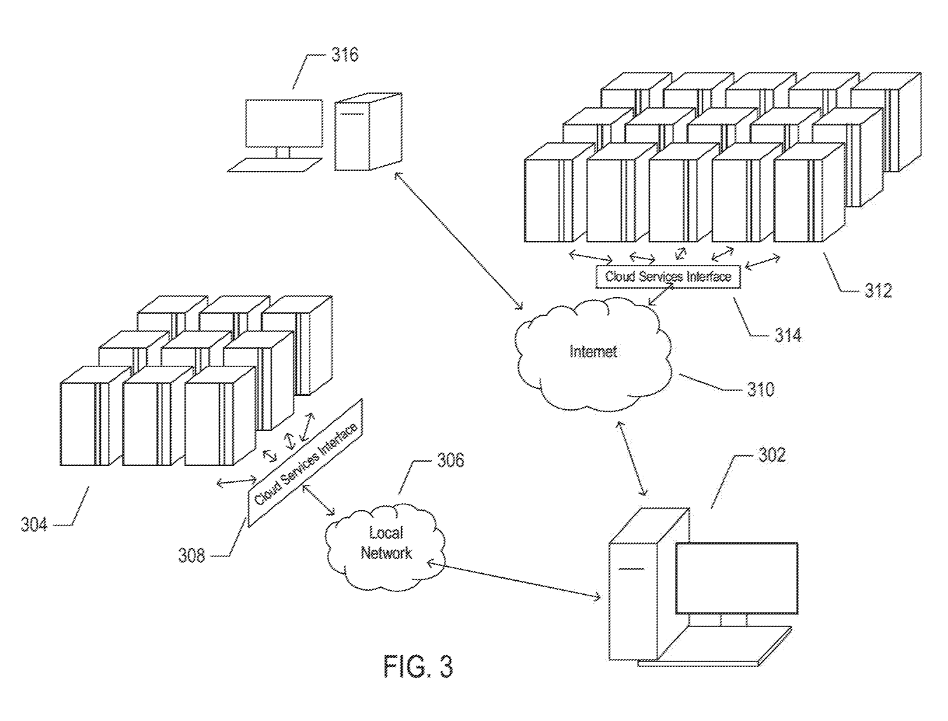

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

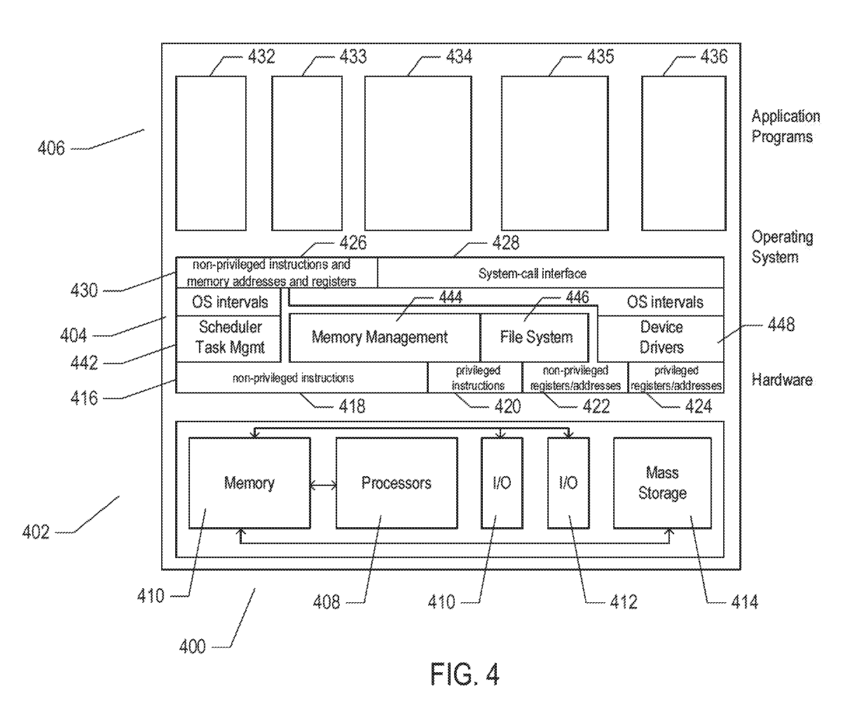

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modem operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

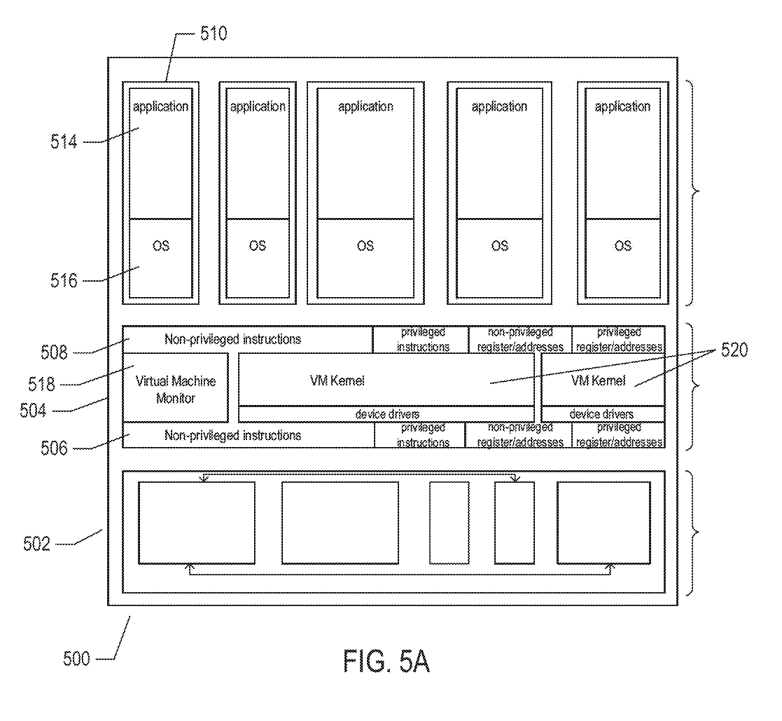

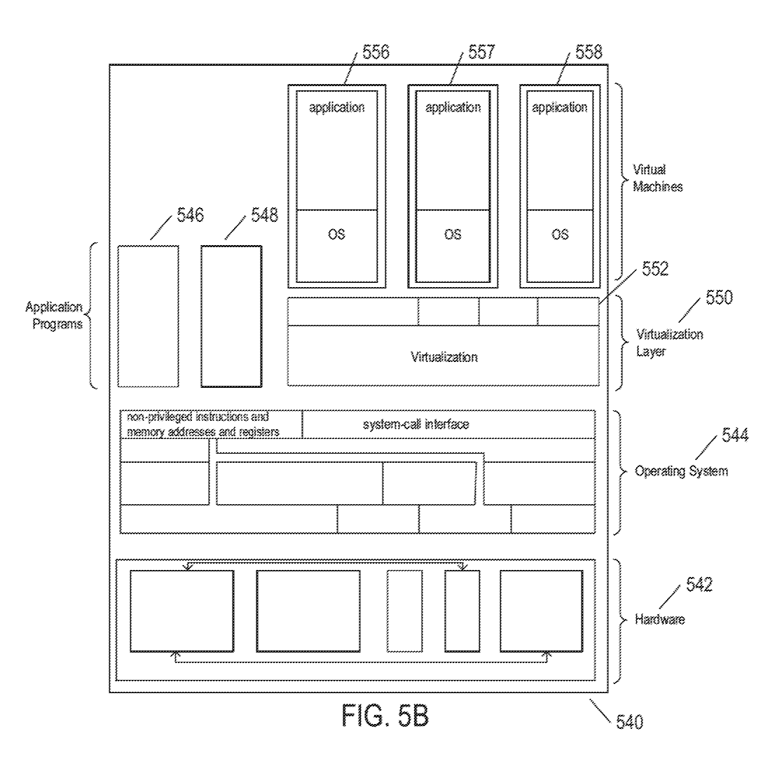

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

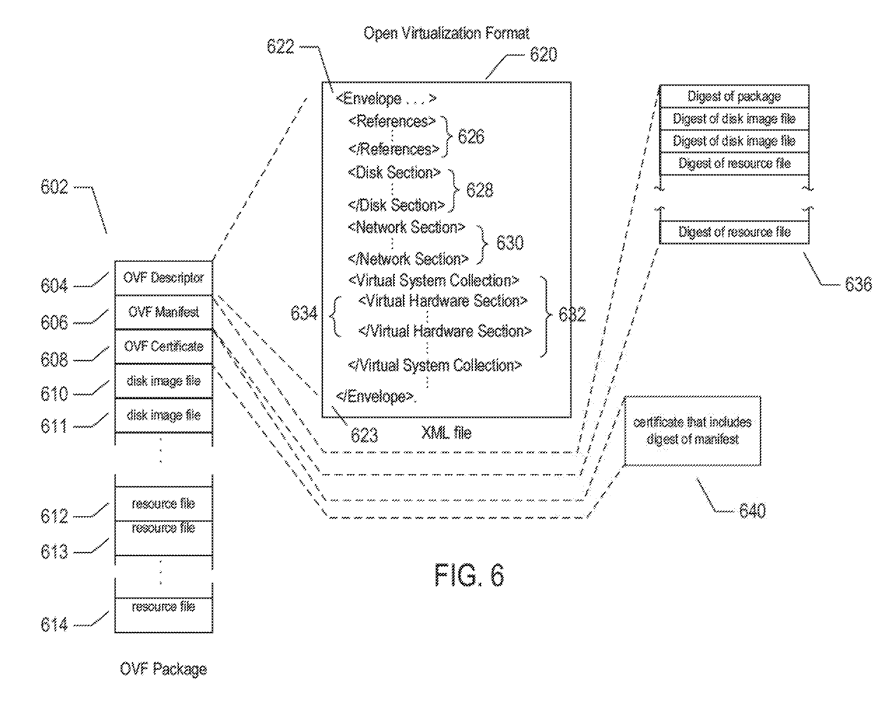

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

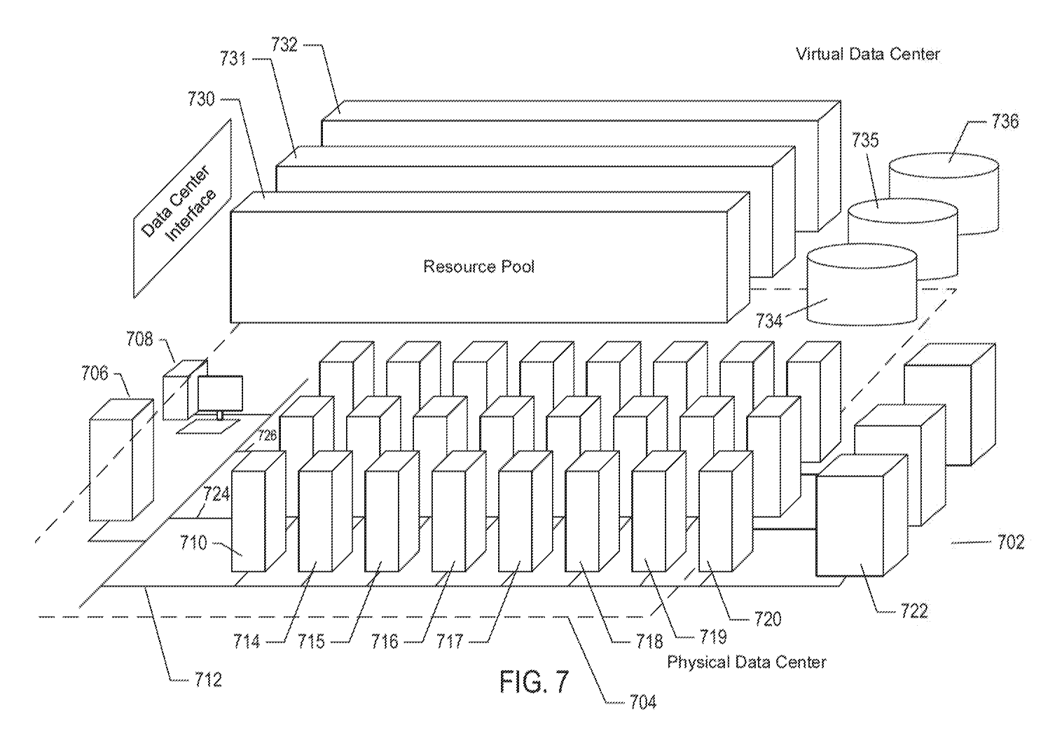

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

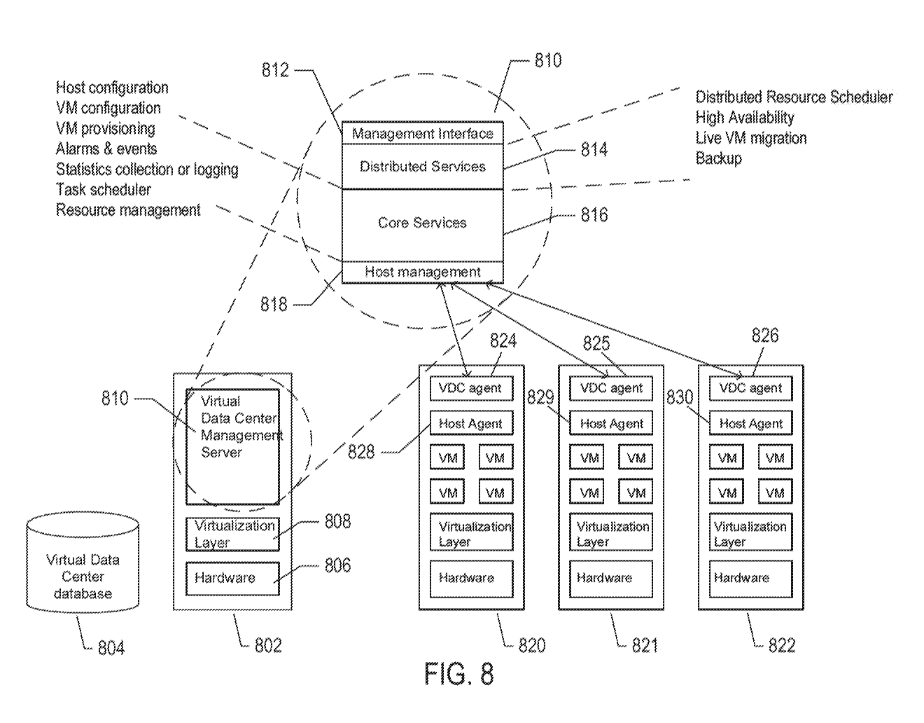

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808, and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

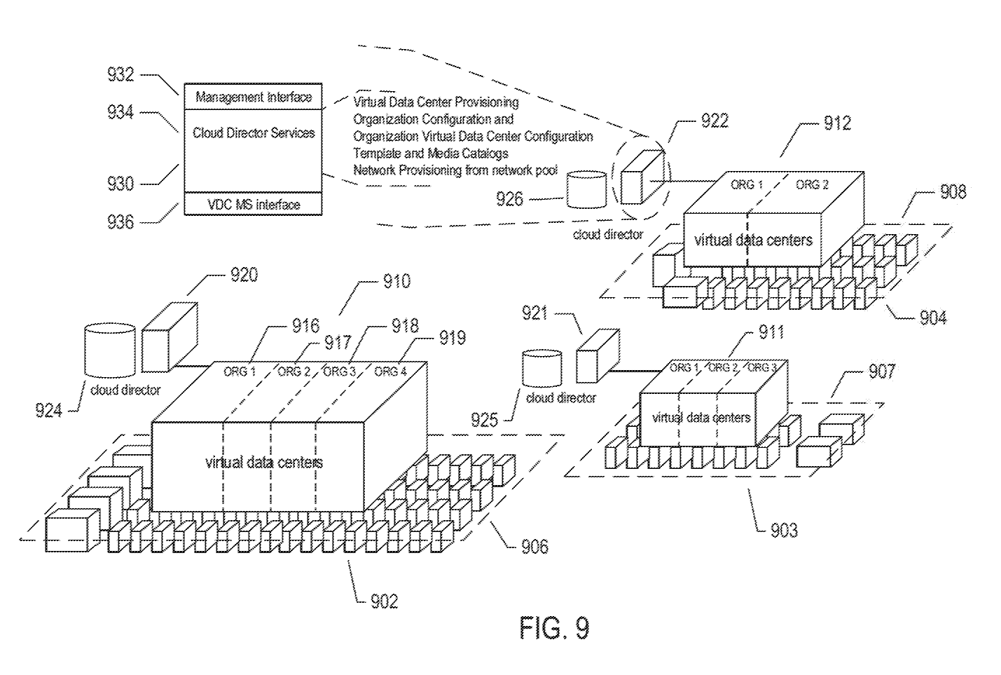

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

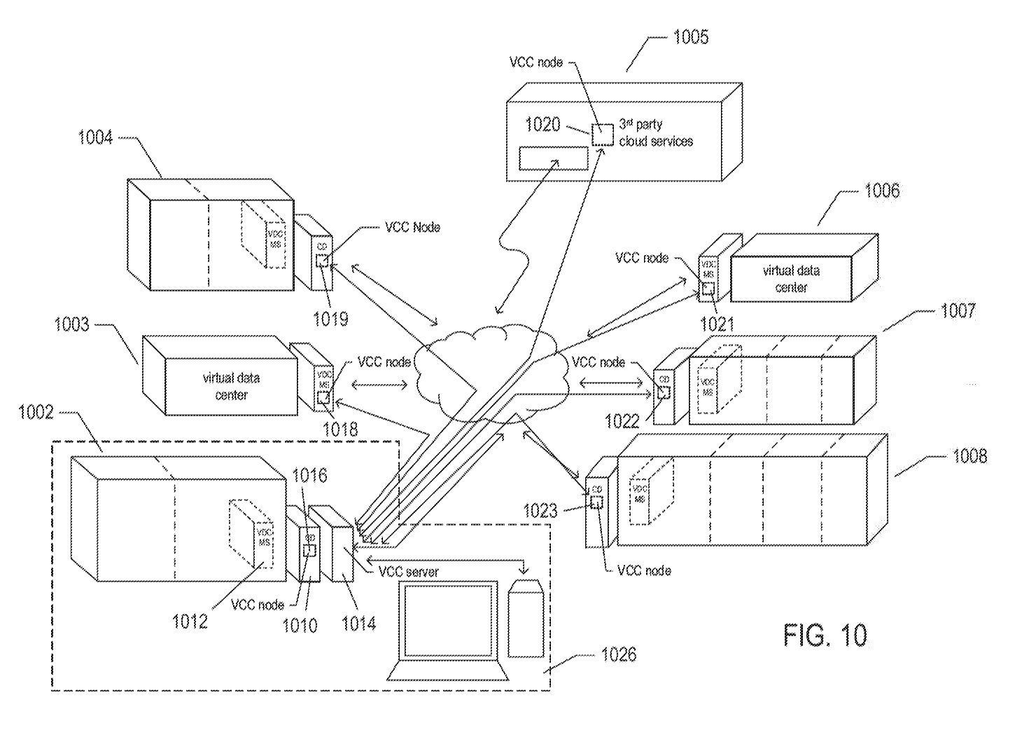

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Workflow-Based Cloud Management

FIG. 11 shows workflow-based cloud-management facility that has been developed to provide a powerful administrative and development interface to multiple multi-tenant cloud-computing facilities. The workflow-based management, administration, and development facility (“WFMAD”) is used to manage and administer cloud-computing aggregations, such as those discussed above with reference to FIG. 10, cloud-computing aggregations, such as those discussed above with reference to FIG. 9, and a variety of additional types of cloud-computing facilities as well as to deploy applications and continuously and automatically release complex applications on various types of cloud-computing aggregations. As shown in FIG. 11, the WFMAD 1102 is implemented above the physical hardware layers 1104 and 1105 and virtual data centers 1106 and 1107 of a cloud-computing facility or cloud-computing-facility aggregation. The WFMAD includes a workflow-execution engine and development environment 1110, an application-deployment facility 1112, an infrastructure-management-and-administration facility 1114, and an automated-application-release-management facility 1116. The workflow-execution engine and development environment 1110 provides an integrated development environment for constructing, validating, testing, and executing graphically expressed workflows, discussed in detail below. Workflows are high-level programs with many built-in functions, scripting tools, and development tools and graphical interfaces. Workflows provide an underlying foundation for the infrastructure-management-and-administration facility 1114, the application-development facility 1112, and the automated-application-release-management facility 1116. The infrastructure-management-and-administration facility 1114 provides a powerful and intuitive suite of management and administration tools that allow the resources of a cloud-computing facility or cloud-computing-facility aggregation to be distributed among clients and users of the cloud-computing facility or facilities and to be administered by a hierarchy of general and specific administrators. The infrastructure-management-and-administration facility 1114 provides interfaces that allow service architects to develop various types of services and resource descriptions that can be provided to users and clients of the cloud-computing facility or facilities, including many management and administrative services and functionalities implemented as workflows. The application-deployment facility 1112 provides an integrated application-deployment environment to facilitate building and launching complex cloud-resident applications on the cloud-computing facility or facilities. The application-deployment facility provides access to one or more artifact repositories that store and logically organize binary files and other artifacts used to build complex cloud-resident applications as well as access to automated tools used, along with workflows, to develop specific automated application-deployment tools for specific cloud-resident applications. The automated-application-release-management facility 1116 provides workflow-based automated release-management tools that enable cloud-resident-application developers to continuously generate application releases produced by automated deployment, testing, and validation functionalities. Thus, the WFMAD 1102 provides a powerful, programmable, and extensible management, administration, and development platform to allow cloud-computing facilities and cloud-computing-facility aggregations to be used and managed by organizations and teams of individuals.

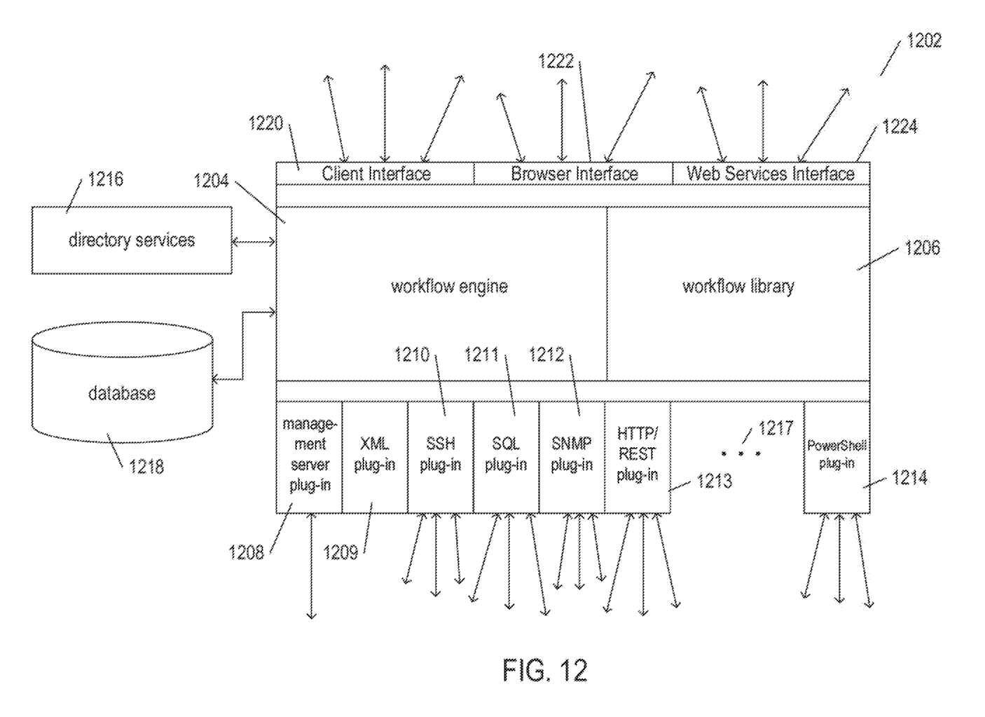

Next, the workflow-execution engine and development environment is discussed in grater detail. FIG. 12 provides an architectural diagram of the workflow-execution engine and development environment. The workflow-execution engine and development environment 1202 includes a workflow engine 1204, which executes workflows to carry out the many different administration, management, and development tasks encoded in workflows that comprise the functionalities of the WFMAD. The workflow engine, during execution of workflows, accesses many built-in tools and functionalities provided by a workflow library 1206. In addition, both the routines and functionalities provided by the workflow library and the workflow engine access a wide variety of tools and computational facilities, provided by a wide variety of third-party providers, through a large set of plug-ins 1208-1214. Note that the ellipses 1216 indicate that many additional plug-ins provide, to the workflow engine and workflow-library routines, access to many additional third-party computational resources. Plug-in 1208 provides for access, by the workflow engine and workflow-library routines, to a cloud-computing-facility or cloud-computing-facility-aggregation management server, such as a cloud director (920 in FIG. 9) or VCC server (1014 in FIG. 10). The XML plug-in 1209 provides access to a complete document object model (“DOM”) extensible markup language (“XML”) parser. The SSH plug-in 1210 provides access to an implementation of the Secure Shell v2 (“SSH-2”) protocol. The structured query language (“SQL”) plug-in 1211 provides access to a Java database connectivity (“JDBC”) API that, in turn, provides access to a wide range of different types of databases. The simple network management protocol (“SNMP”) plug-in 1212 provides access to an implementation of the SNMP protocol that allows the workflow-execution engine and development environment to connect to, and receive information from, various SNMP-enabled systems and devices. The hypertext transfer protocol (“HTTP”)/representational state transfer (‘REST”) plug-in 1213 provides access to REST web services and hosts. The PowerShell plug-in 1214 allows the workflow-execution engine and development environment to manage PowerShell hosts and run custom PowerShell operations. The workflow engine 1204 additionally accesses directory services 1216, such as a lightweight directory access protocol (“LDAP”) directory, that maintain distributed directory information and manages password-based user login. The workflow engine also accesses a dedicated database 1218 in which workflows and other information are stored. The workflow-execution engine and development environment can be accessed by clients running a client application that interfaces to a client interface 1220, by clients using web browsers that interface to a browser interface 1222, and by various applications and other executables running on remote computers that access the workflow-execution engine and development environment using a REST or small-object-access protocol (“SOAP”) via a web-services interface 1224. The client application that runs on a remote computer and interfaces to the client interface 1220 provides a powerful graphical user interface that allows a client to develop and store workflows for subsequent execution by the workflow engine. The user interface also allows clients to initiate workflow execution and provides a variety of tools for validating and debugging workflows. Workflow execution can be initiated via the browser interface 1222 and web-services interface 1224. The various interfaces also provide for exchange of data output by workflows and input of parameters and data to workflows.

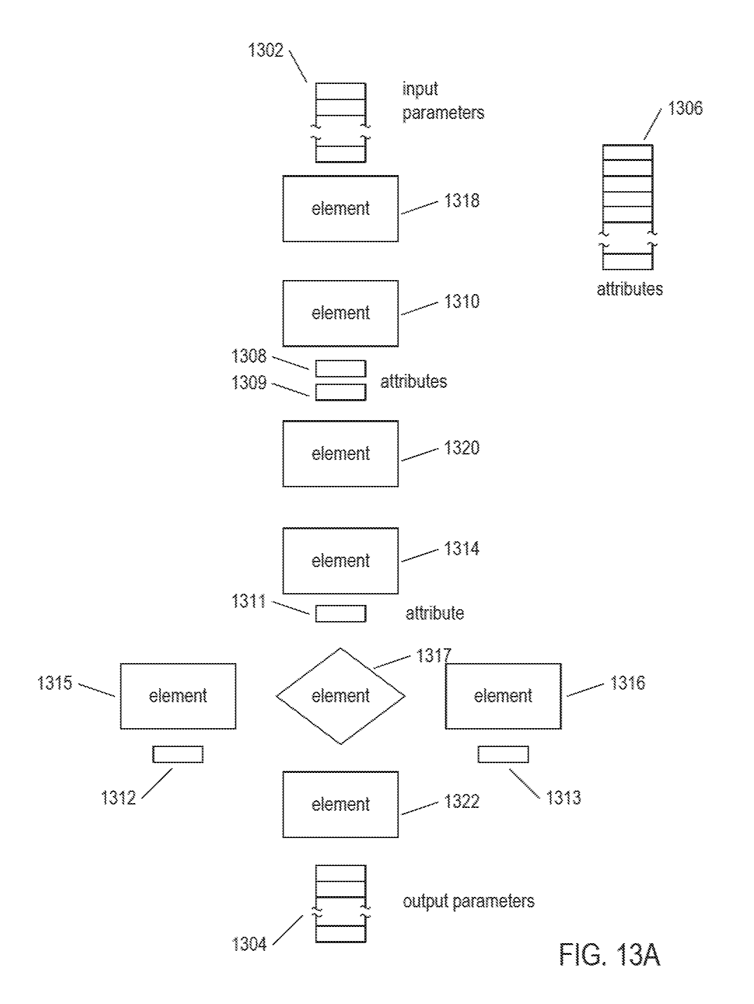

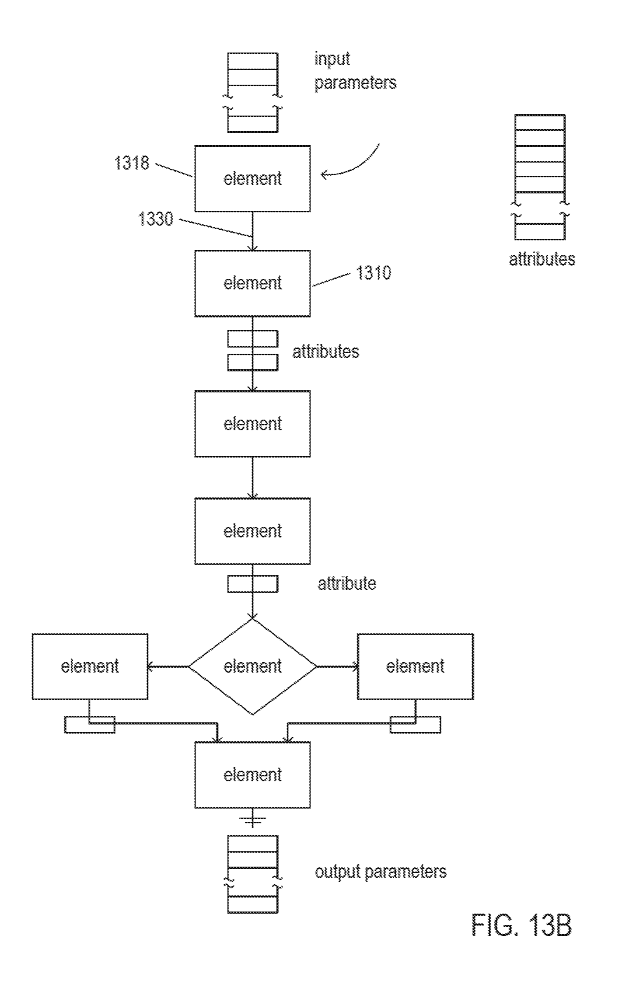

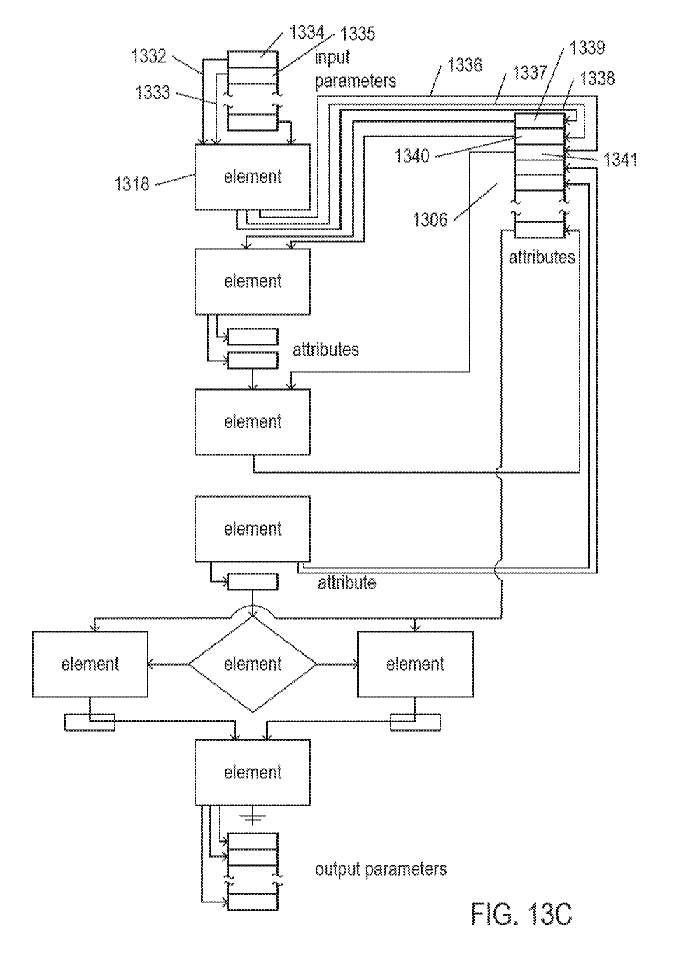

FIGS. 13A-C illustrate the structure of a workflow. A workflow is a graphically represented high-level program. FIG. 13A shows the main logical components of a workflow. These components include a set of one or more input parameters 1302 and a set of one or more output parameters 1304. In certain cases, a workflow may not include input and/or output parameters, but, in general, both input parameters and output parameters are defined for each workflow. The input and output parameters can have various different data types, with the values for a parameter depending on the data type associated with the parameter. For example, a parameter may have a string data type, in which case the values for the parameter can include any alphanumeric string or Unicode string of up to a maximum length. A workflow also generally includes a set of parameters 1306 that store values manipulated during execution of the workflow. This set of parameters is similar to a set of global variables provided by many common programming languages. In addition, attributes can be defined within individual elements of a workflow, and can be used to pass values between elements. In FIG. 13A, for example, attributes 1308-1309 are defined within element 1310 and attributes 1311, 1312, and 1313 are defined within elements 1314, 1315, and 1316, respectively. Elements, such as elements 1318, 1310, 1320, 1314-1316, and 1322 in FIG. 13A, are the execution entities within a workflow. Elements are equivalent to one or a combination of common constructs in programming languages, including subroutines, control structures, error handlers, and facilities for launching asynchronous and synchronous procedures. Elements may correspond to script routines, for example, developed to carry out an almost limitless number of different computational tasks. Elements are discussed, in greater detail, below.

As shown in FIG. 13B, the logical control flow within a workflow is specified by links, such as link 1330 which indicates that element 1310 is executed following completion of execution of element 1318. In FIG. 13B, links between elements are represented as single-headed arrows. Thus, links provide the logical ordering that is provided, in a common programming language, by the sequential ordering of statements. Finally, as shown in FIG. 13C, bindings that bind input parameters, output parameters, and attributes to particular roles with respect to elements specify the logical data flow in a workflow. In FIG. 13C, single-headed arrows, such as single-headed arrow 1332, represent bindings between elements and parameters and attributes. For example, bindings 1332 and 1333 indicate that the values of the first input parameters 1334 and 1335 are input to element 1318. Thus, the first two input parameters 1334-1335 play similar roles as arguments to functions in a programming language. As another example, the bindings represented by arrows 1336-1338 indicate that element 1318 outputs values that are stored in the first three attributes 1339, 1340, and 1341 of the set of attributes 1306.

Thus, a workflow is a graphically specified program, with elements representing executable entities, links representing logical control flow, and bindings representing logical data flow. A workflow can be used to specific arbitrary and arbitrarily complex logic, in a similar fashion as the specification of logic by a compiled, structured programming language, an interpreted language, or a script language.

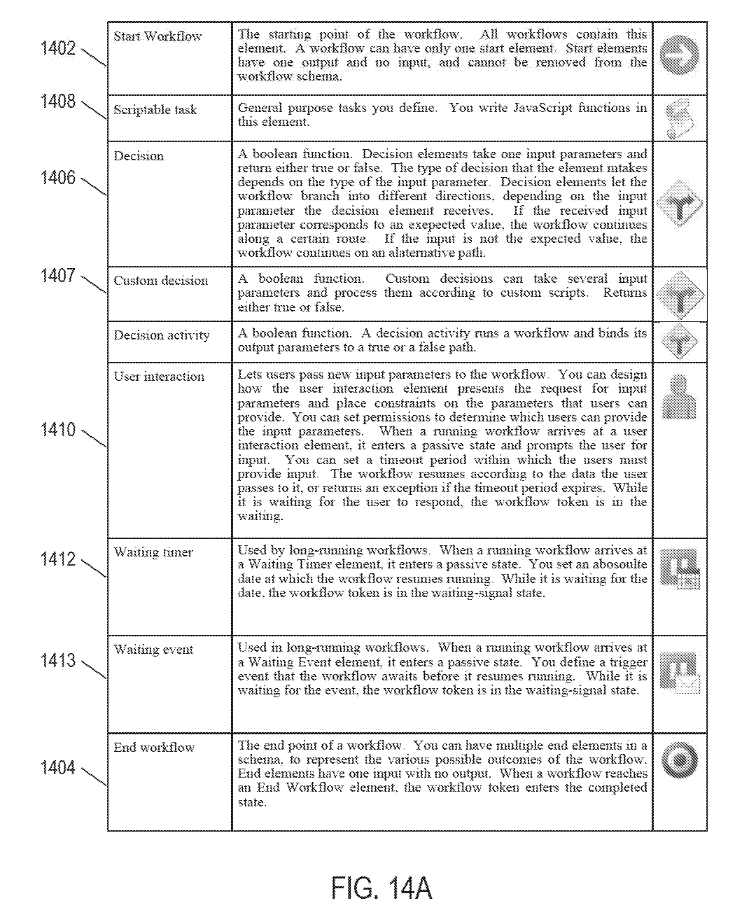

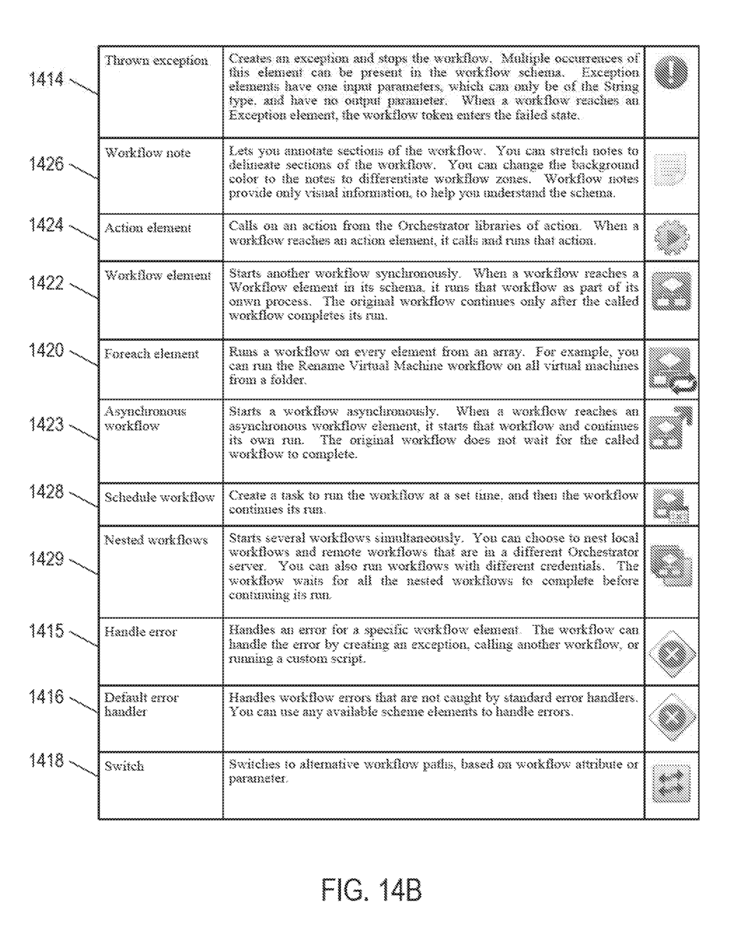

FIGS. 14A-B include a table of different types of elements that may be included in a workflow. Workflow elements may include a start-workflow element 1402 and an end-workflow element 1404, examples of which include elements 1318 and 1322, respectively, in FIG. 13A. Decision workflow elements 1406-1407, an example of which is element 1317 in FIG. 13A, function as an if-then-else construct commonly provided by structured programming languages. Scriptable-task elements 1408 are essentially script routines included in a workflow. A user-interaction element 1410 solicits input from a user during workflow execution. Waiting-timer and waiting-event elements 1412-1413 suspend workflow execution for a specified period of time or until the occurrence of a specified event. Thrown-exception elements 1414 and error-handling elements 1415-1416 provide functionality commonly provided by throw-catch constructs in common programming languages. A switch element 1418 dispatches control to one of multiple paths, similar to switch statements in common programming languages, such as C and C++. A foreach element 1420 is a type of iterator. External workflows can be invoked from a currently executing workflow by a workflow element 1422 or asynchronous-workflow element 1423. An action element 1424 corresponds to a call to a workflow-library routine. A workflow-note element 1426 represents a comment that can be included within a workflow. External workflows can also be invoked by schedule-workflow and nested-workflows elements 1428 and 1429.

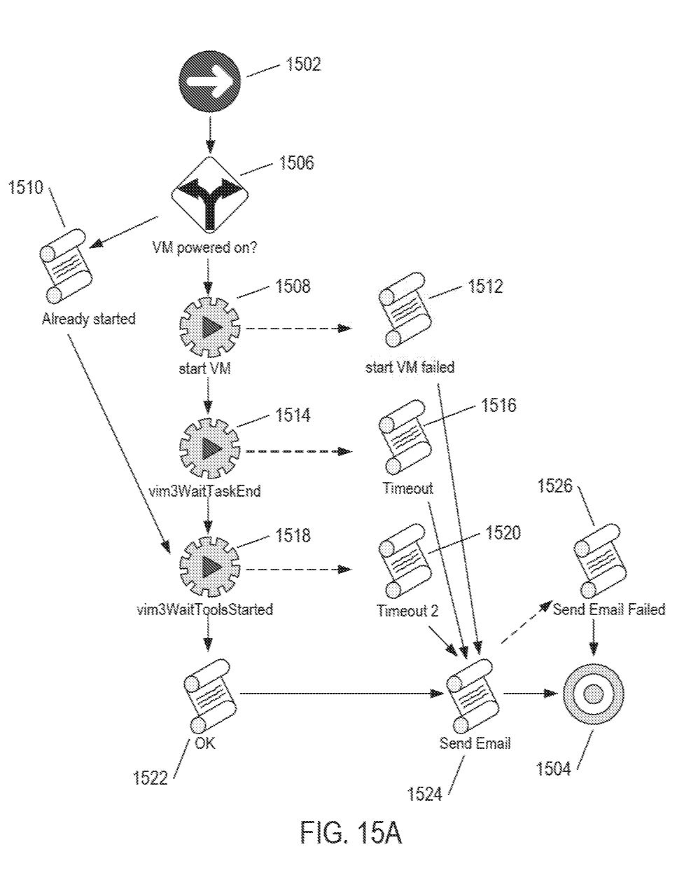

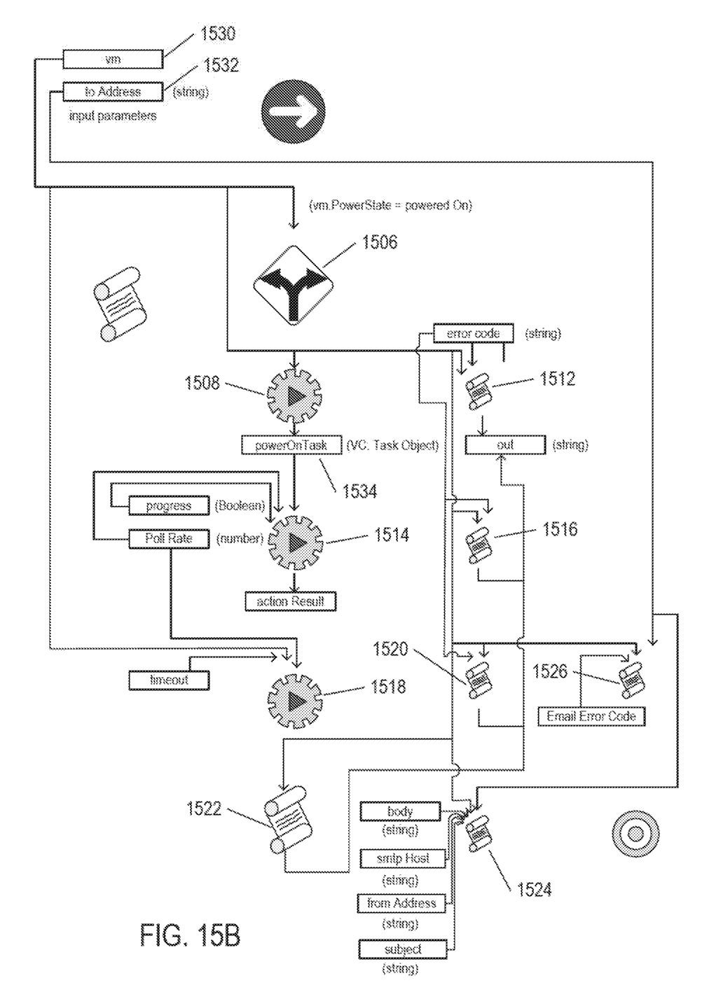

FIGS. 15A-B show an example workflow. The workflow shown in FIG. 15A is a virtual-machine-starting workflow that prompts a user to select a virtual machine to start and provides an email address to receive a notification of the outcome of workflow execution. The prompts are defined as input parameters. The workflow includes a start-workflow element 1502 and an end-workflow element 1504. The decision element 1506 checks to see whether or not the specified virtual machine is already powered on. When the VM is not already powered on, control flows to a start-VM action 1508 that calls a workflow-library function to launch the VM. Otherwise, the fact that the VM was already powered on is logged, in an already-started scripted element 1510. When the start operation fails, a start-VM-failed scripted element 1512 is executed as an exception handler and initializes an email message to report the failure. Otherwise, control flows to a vim3WaitTaskEnd action element 1514 that monitors the VM-starting task. A timeout exception handler is invoked when the start-VM task does not finish within a specified time period. Otherwise, control flows to a vim3WaitToolsStarted task 1518 which monitors starting of a tools application on the virtual machine. When the tools application fails to start, then a second timeout exception handler is invoked 1520. When all the tasks successfully complete, an OK scriptable task 1522 initializes an email body to report success. The email that includes either an error message or a success message is sent in the send-email scriptable task 1524. When sending the email fails, an email exception handler 1526 is called. The already-started, OK, and exception-handler scriptable elements 1510, 1512, 1516, 1520, 1522, and 1526 all log entries to a log file to indicate various conditions and errors. Thus, the workflow shown in FIG. 15A is a simple workflow that allows a user to specify a VM for launching to run an application.

FIG. 15B shows the parameter and attribute bindings for the workflow shown in FIG. 15A. The VM to start and the address to send the email are shown as input parameters 1530 and 1532. The VM to start is input to decision element 1506, start-VM action element 1508, the exception handlers 1512, 1516, 1520, and 1526, the send-email element 1524, the OK element 1522, and the vim3WaitToolsStarted element 1518. The email address furnished as input parameter 1532 is input to the email exception handler 1526 and the send-email element 1524. The VM-start task 1508 outputs an indication of the power on task initiated by the element in attribute 1534 which is input to the vim3WaitTaskEnd action element 1514. Other attribute bindings, input, and outputs are shown in FIG. 15B by additional arrows.

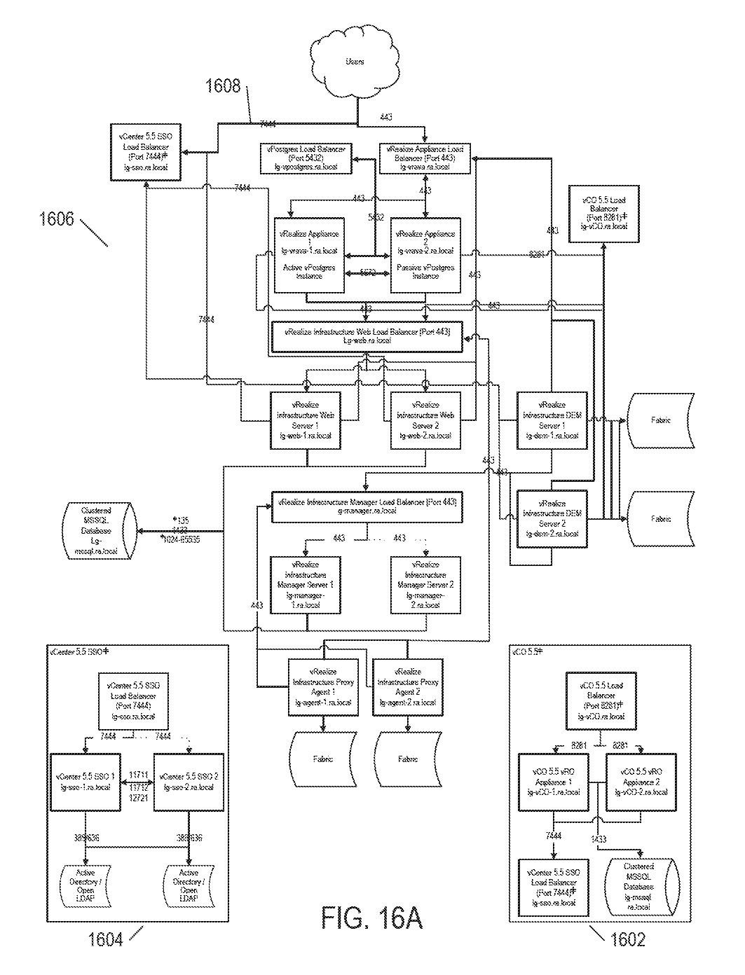

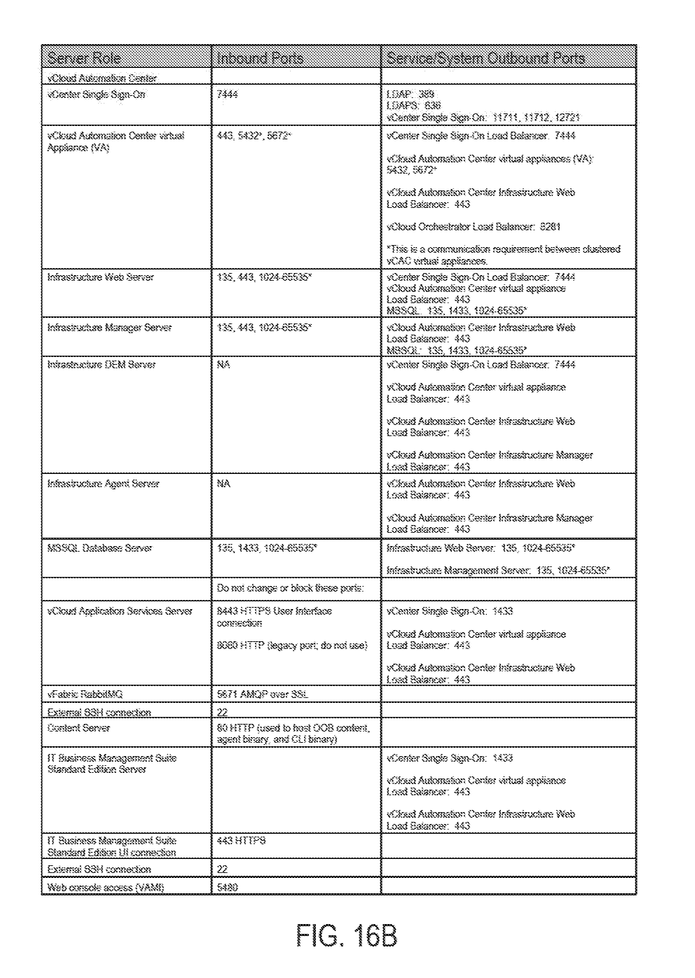

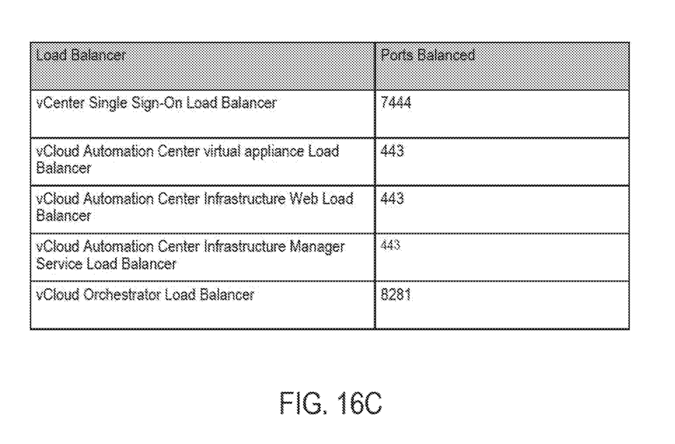

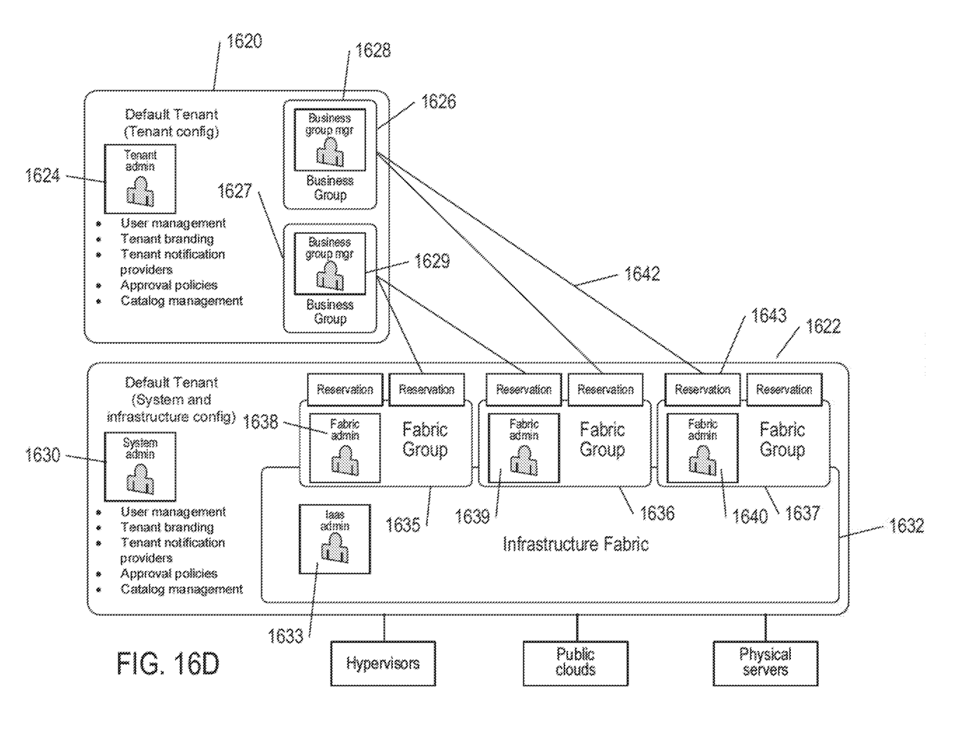

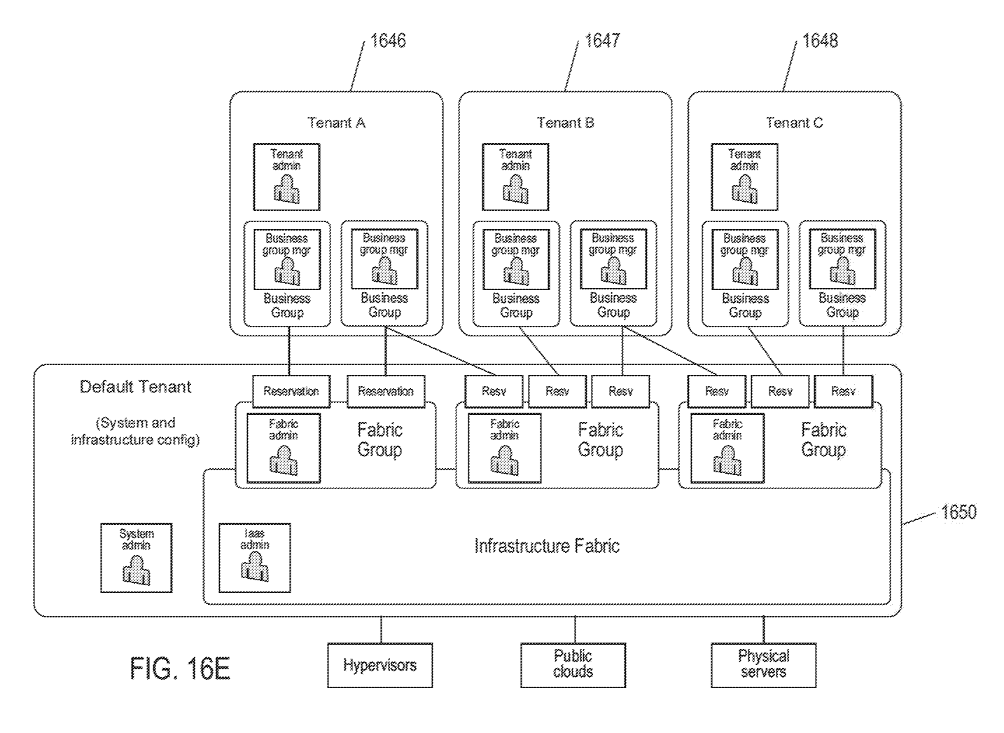

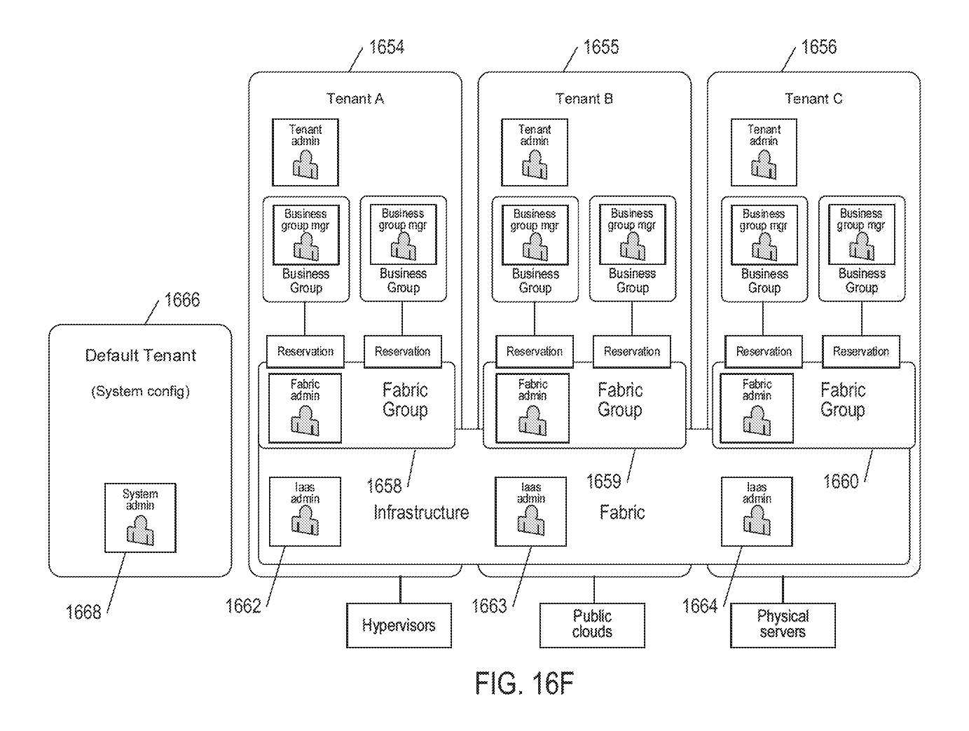

FIGS. 16A-C illustrate an example implementation and configuration of virtual appliances within a cloud-computing facility that implement the workflow-based management and administration facilities of the above-described WFMAD. FIG. 16A shows a configuration that includes the workflow-execution engine and development environment 1602, a cloud-computing facility 1604, and the infrastructure-management-and-administration facility 1606 of the above-described WFMAD. Data and information exchanges between components are illustrated with arrows, such as arrow 1608, labeled with port numbers indicating inbound and outbound ports used for data and information exchanges. FIG. 16B provides a table of servers, the services provided by the server, and the inbound and outbound ports associated with the server. Table 16C indicates the ports balanced by various load balancers shown in the configuration illustrated in FIG. 16A. It can be easily ascertained from FIGS. 16A-C that the WFMAD is a complex, multi-virtual-appliance/virtual-server system that executes on many different physical devices of a physical cloud-computing facility.

FIGS. 16D-F illustrate the logical organization of users and user roles with respect to the infrastructure-management-and-administration facility of the WFMAD (1114 in FIG. 11). FIG. 16D shows a single-tenant configuration, FIG. 16E shows a multi-tenant configuration with a single default-tenant infrastructure configuration, and FIG. 16F shows a multi-tenant configuration with a multi-tenant infrastructure configuration. A tenant is an organizational unit, such as a business unit in an enterprise or company that subscribes to cloud services from a service provider. When the infrastructure-management-and-administration facility is initially deployed within a cloud-computing facility or cloud-computing-facility aggregation, a default tenant is initially configured by a system administrator. The system administrator designates a tenant administrator for the default tenant as well as an identity store, such as an active-directory server, to provide authentication for tenant users, including the tenant administrator. The tenant administrator can then designate additional identity stores and assign roles to users or groups of the tenant, including business groups, which are sets of users that correspond to a department or other organizational unit within the organization corresponding to the tenant. Business groups are, in turn, associated with a catalog of services and infrastructure resources. Users and groups of users can be assigned to business groups. The business groups, identity stores, and tenant administrator are all associated with a tenant configuration. A tenant is also associated with a system and infrastructure configuration. The system and infrastructure configuration includes a system administrator and an infrastructure fabric that represents the virtual and physical computational resources allocated to the tenant and available for provisioning to users. The infrastructure fabric can be partitioned into fabric groups, each managed by a fabric administrator. The infrastructure fabric is managed by an infrastructure-as-a-service (“IAAS”) administrator. Fabric-group computational resources can be allocated to business groups by using reservations.

FIG. 16D shows a single-tenant configuration for an infrastructure-management-and-administration facility deployment within a cloud-computing facility or cloud-computing-facility aggregation. The configuration includes a tenant configuration 1620 and a system and infrastructure configuration 1622. The tenant configuration 1620 includes a tenant administrator 1624 and several business groups 1626-1627, each associated with a business-group manager 1628-1629, respectively. The system and infrastructure configuration 1622 includes a system administrator 1630, an infrastructure fabric 1632 managed by an IAAS administrator 1633, and three fabric groups 1635-1637, each managed by a fabric administrator 1638-1640, respectively. The computational resources represented by the fabric groups are allocated to business groups by a reservation system, as indicated by the lines between business groups and reservation blocks, such as line 1642 between reservation block 1643 associated with fabric group 1637 and the business group 1626.

FIG. 16E shows a multi-tenant single-tenant-system-and-infrastructure-configuration deployment for an infrastructure-management-and-administration facility of the WFMAD. In this configuration, there are three different tenant organizations, each associated with a tenant configuration 1646-1648. Thus, following configuration of a default tenant, a system administrator creates additional tenants for different organizations that together share the computational resources of a cloud-computing facility or cloud-computing-facility aggregation. In general, the computational resources are partitioned among the tenants so that the computational resources allocated to any particular tenant are segregated from and inaccessible to the other tenants. In the configuration shown in FIG. 16E, there is a single default-tenant system and infrastructure configuration 1650, as in the previously discussed configuration shown in FIG. 16D.

FIG. 16F shows a multi-tenant configuration in which each tenant manages its own infrastructure fabric. As in the configuration shown in FIG. 16E, there are three different tenants 1654-1656 in the configuration shown in FIG. 16F. However, each tenant is associated with its own fabric group 1658-1660, respectively, and each tenant is also associated with an infrastructure-fabric IAAS administrator 1662-1664, respectively. A default-tenant system configuration 1666 is associated with a system administrator 1668 who administers the infrastructure fabric, as a whole.

System administrators, as mentioned above, generally install the WFMAD within a cloud-computing facility or cloud-computing-facility aggregation, create tenants, manage system-wide configuration, and are generally responsible for insuring availability of WFMAD services to users, in general. IAAS administrators create fabric groups, configure virtualization proxy agents, and manage cloud service accounts, physical machines, and storage devices. Fabric administrators manage physical machines and computational resources for their associated fabric groups as well as reservations and reservation policies through which the resources are allocated to business groups. Tenant administrators configure and manage tenants on behalf of organizations. They manage users and groups within the tenant organization, track resource usage, and may initiate reclamation of provisioned resources. Service architects create blueprints for items stored in user service catalogs which represent services and resources that can be provisioned to users. The infrastructure-management-and-administration facility defines many additional roles for various administrators and users to manage provision of services and resources to users of cloud-computing facilities and cloud-computing facility aggregations.

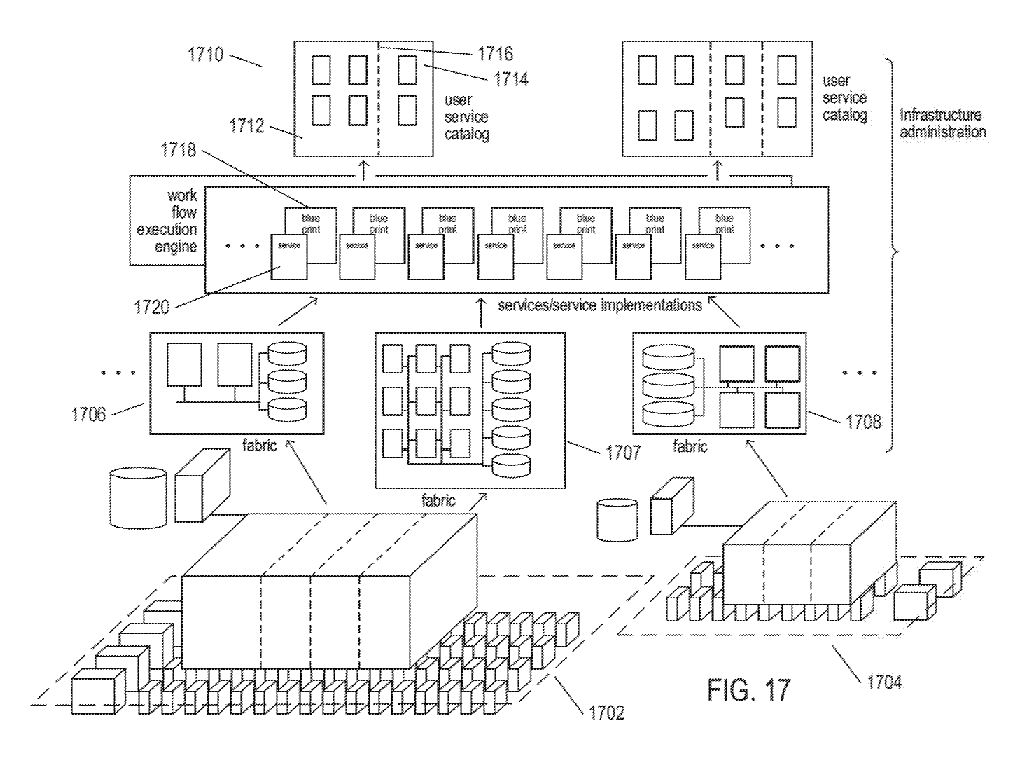

FIG. 17 illustrates the logical components of the infrastructure-management-and-administration facility (1114 in FIG. 11) of the WFMAD. As discussed above, the WFMAD is implemented within, and provides a management and development interface to, one or more cloud-computing facilities 1702 and 1704. The computational resources provided by the cloud-computing facilities, generally in the form of virtual servers, virtual storage devices, and virtual networks, are logically partitioned into fabrics 1706-1708. Computational resources are provisioned from fabrics to users. For example, a user may request one or more virtual machines running particular applications. The request is serviced by allocating the virtual machines from a particular fabric on behalf of the user. The services, including computational resources and workflow-implemented tasks, which a user may request provisioning of, are stored in a user service catalog, such as user service catalog 1710, that is associated with particular business groups and tenants. In FIG. 17, the items within a user service catalog are internally partitioned into categories, such as the two categories 1712 and 1714 and separated logically by vertical dashed line 1716. User access to catalog items is controlled by entitlements specific to business groups. Business group managers create entitlements that specify which users and groups within the business group can access particular catalog items. The catalog items are specified by service-architect-developed blueprints, such as blueprint 1718 for service 1720. The blueprint is a specification for a computational resource or task-service and the service itself is implemented by a workflow that is executed by the workflow-execution engine on behalf of a user.

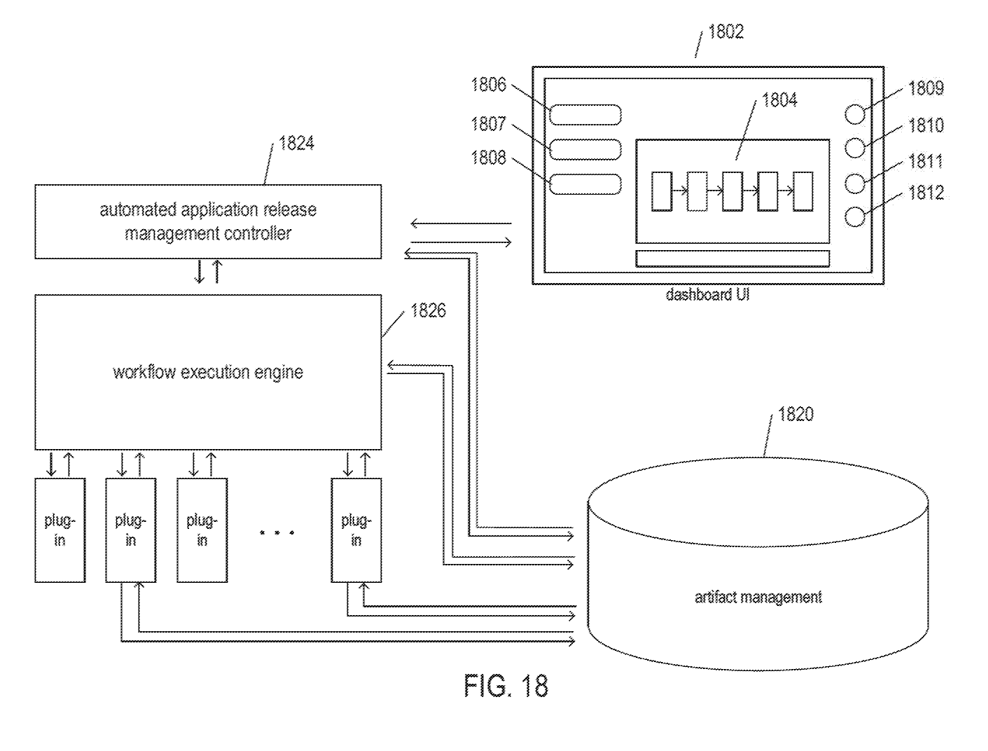

FIGS. 18-20B provide a high-level illustration of the architecture and operation of the automated-application-release-management facility (1116 in FIG. 11) of the WFMAD. The application-release management process involves storing, logically organizing, and accessing a variety of different types of binary files and other files that represent executable programs and various types of data that are assembled into complete applications that are released to users for running on virtual servers within cloud-computing facilities. Previously, releases of new version of applications may have occurred over relatively long time intervals, such as biannually, yearly, or at even longer intervals. Minor versions were released at shorter intervals. However, more recently, automated application-release management has provided for continuous release at relatively short intervals in order to provide new and improved functionality to clients as quickly and efficiently as possible.

FIG. 18 shows main components of the automated-application-release-management facility (1116 in FIG. 11). The automated-application-release-management component provides a dashboard user interface 1802 to allow release managers and administrators to launch release pipelines and monitor their progress. The dashboard may visually display a graphically represented pipeline 1804 and provide various input features 1806-1812 to allow a release manager or administrator to view particular details about an executing pipeline, create and edit pipelines, launch pipelines, and generally manage and monitor the entire application-release process. The various binary files and other types of information needed to build and test applications are stored in an artifact-management component 1820. An automated-application-release-management controller 1824 sequentially initiates execution of various workflows that together implement a release pipeline and serves as an intermediary between the dashboard user interface 1802 and the workflow-execution engine 1826.

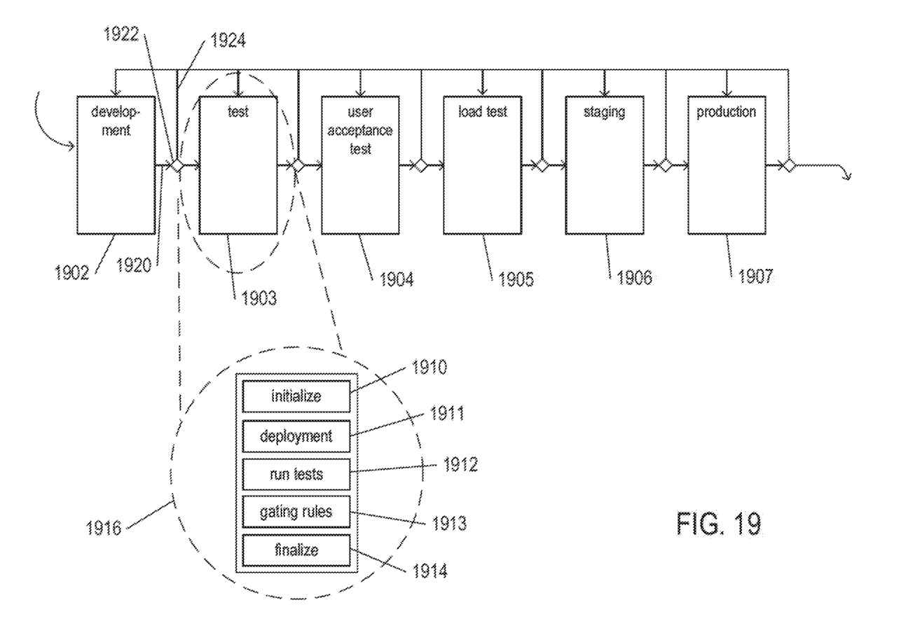

FIG. 19 illustrates a release pipeline. The release pipeline is a sequence of stages 1902 -1907 that each comprises a number of sequentially executed tasks, such as the tasks 1910-1914 shown in inset 1916 that together compose stage 1903. In general, each stage is associated with gating rules that are executed to determine whether or not execution of the pipeline can advance to a next, successive stage. Thus, in FIG. 19, each stage is shown with an output arrow, such as output arrow 1920, that leads to a conditional step, such as conditional step 1922, representing the gating rules. When, as a result of execution of tasks within the stage, application of the gating rules to the results of the execution of the tasks indicates that execution should advance to a next stage, then any final tasks associated with the currently executing stage are completed and pipeline execution advances to a next stage. Otherwise, as indicated by the vertical lines emanating from the conditional steps, such as vertical line 1924 emanating from conditional step 1922, pipeline execution may return to re-execute the current stage or a previous stage, often after developers have supplied corrected binaries, missing data, or taken other steps to allow pipeline execution to advance.

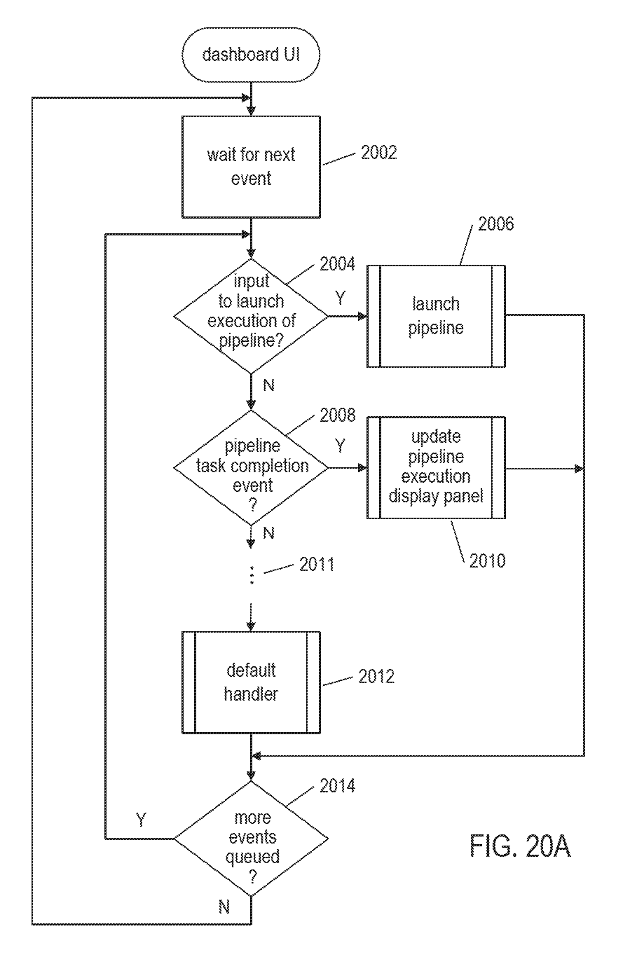

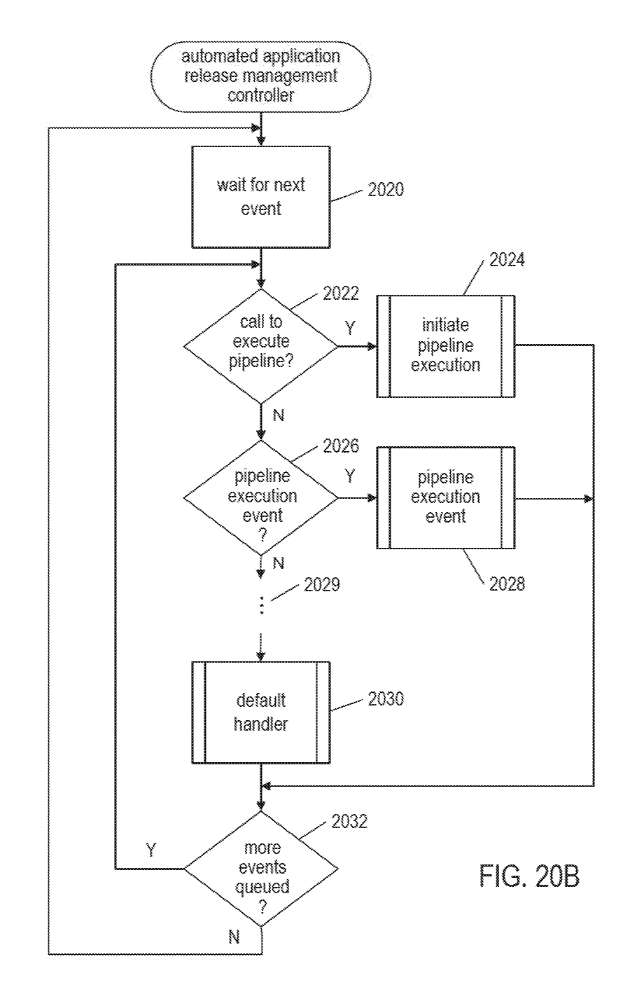

FIGS. 20A-B provide control-flow diagrams that indicate the general nature of dashboard and automated-application-release-management-controller operation. FIG. 20A shows a partial control-flow diagram for the dashboard user interface. In step 2002, the dashboard user interface waits for a next event to occur. When the next occurring event is input, by a release manager, to the dashboard to direct launching of an execution pipeline, as determined in step 2004, then the dashboard calls a launch-pipeline routine 2006 to interact with the automated-application-release-management controller to initiate pipeline execution. When the next-occurring event is reception of a pipeline task-completion event generated by the automated-application-release-management controller, as determined in step 2008, then the dashboard updates the pipeline-execution display panel within the user interface via a call to the routine “update pipeline execution display panel” in step 2010. There are many other events that the dashboard responds to, as represented by ellipses 2011, including many additional types of user input and many additional types of events generated by the automated-application-release-management controller that the dashboard responds to by altering the displayed user interface. A default handler 2012 handles rare or unexpected events. When there are more events queued for processing by the dashboard, as determined in step 2014, then control returns to step 2004. Otherwise, control returns to step 2002 where the dashboard waits for another event to occur.

FIG. 20B shows a partial control-flow diagram for the automated application-release-management controller. The control-flow diagram represents an event loop, similar to the event loop described above with reference to FIG. 20A. In step 2020, the automated application-release-management controller waits for a next event to occur. When the event is a call from the dashboard user interface to execute a pipeline, as determined in step 2022, then a routine is called, in step 2024, to initiate pipeline execution via the workflow-execution engine. When the next-occurring event is a pipeline-execution event generated by a workflow, as determined in step 2026, then a pipeline-execution-event routine is called in step 2028 to inform the dashboard of a status change in pipeline execution as well as to coordinate next steps for execution by the workflow-execution engine. Ellipses 2029 represent the many additional types of events that are handled by the event loop. A default handler 2030 handles rare and unexpected events. When there are more events queued for handling, as determined in step 2032, control returns to step 2022. Otherwise, control returns to step 2020 where the automated application-release-management controller waits for a next event to occur.

### An Automated-Application-Release-Management-Subsystem That Provides for Parameter-Value Exchanges Between Tasks of an Application-Release-Management Pipeline

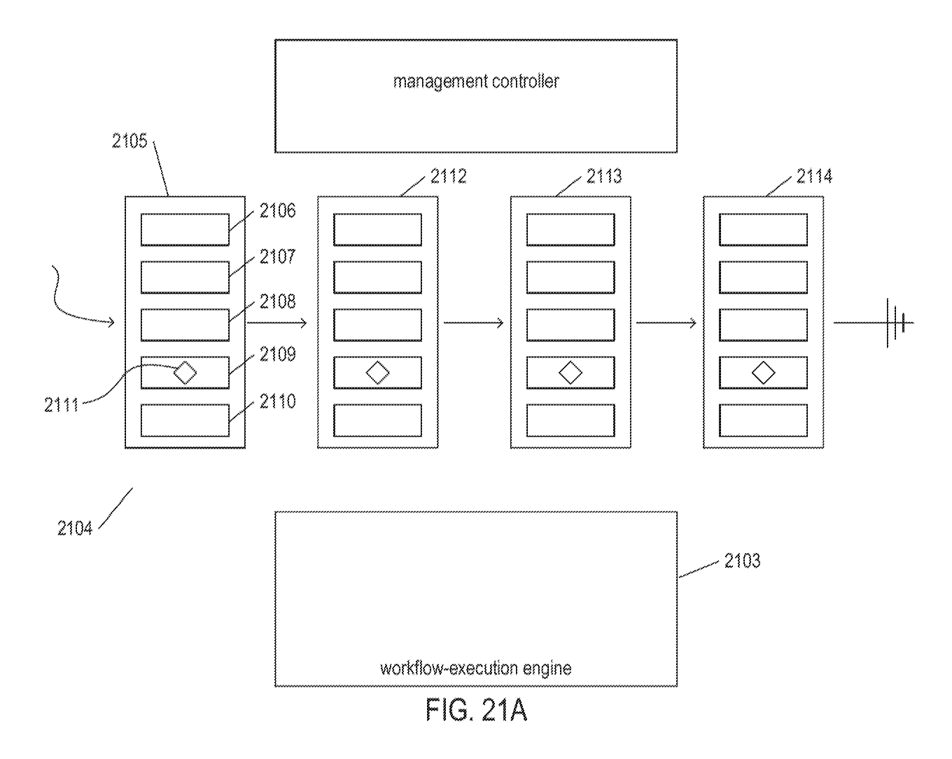

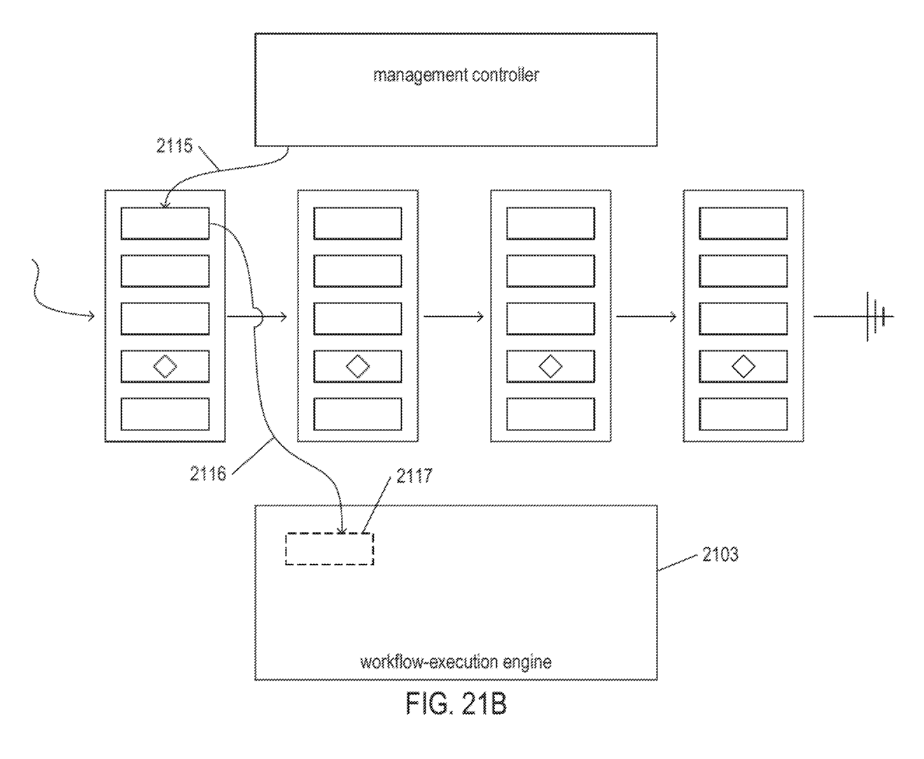

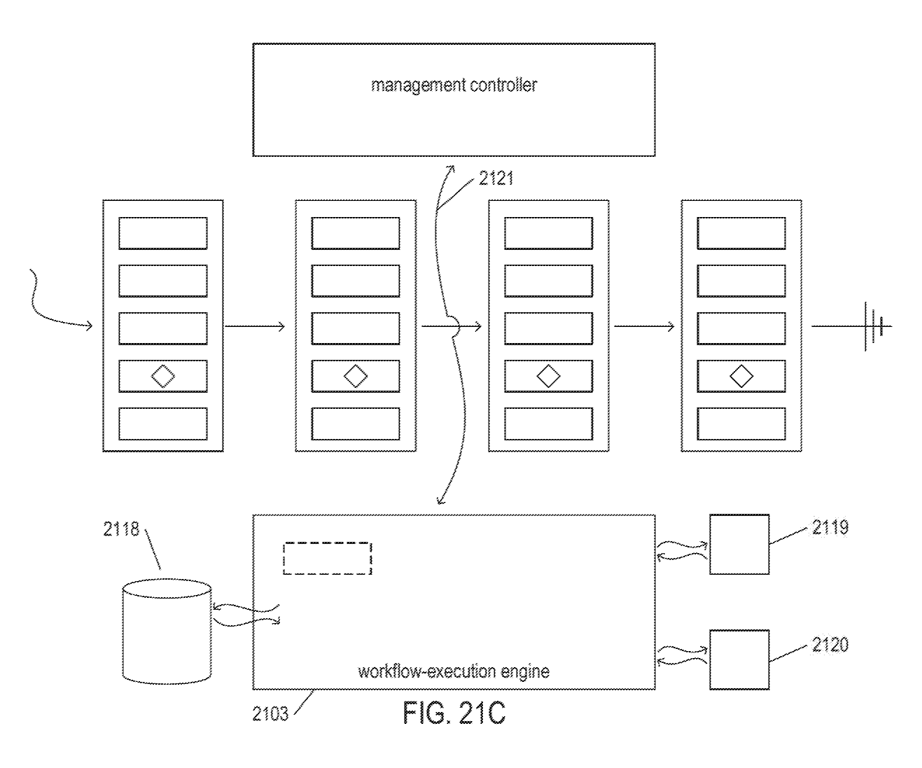

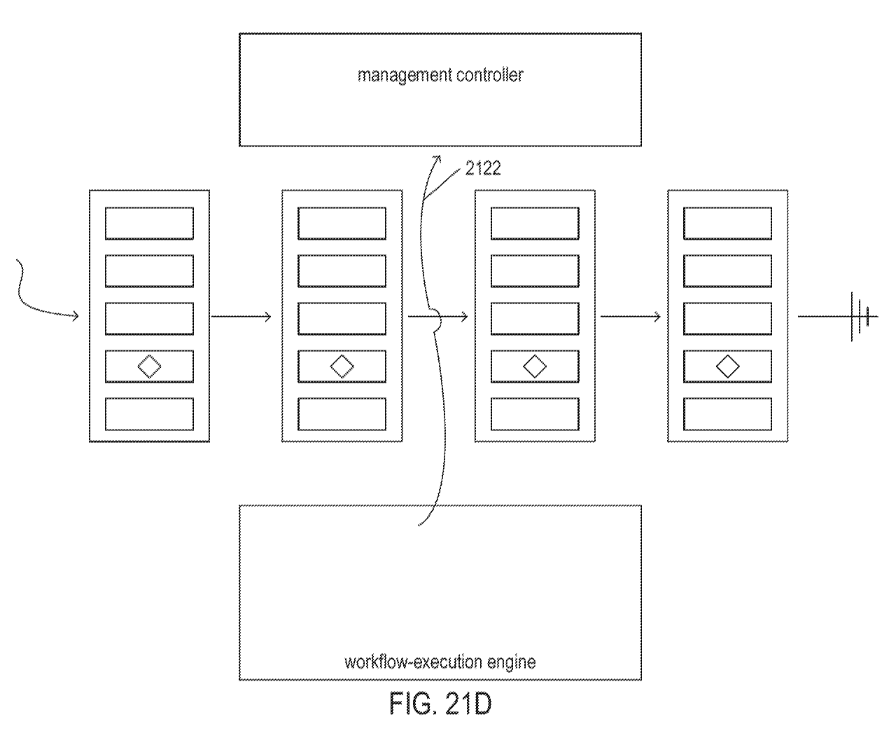

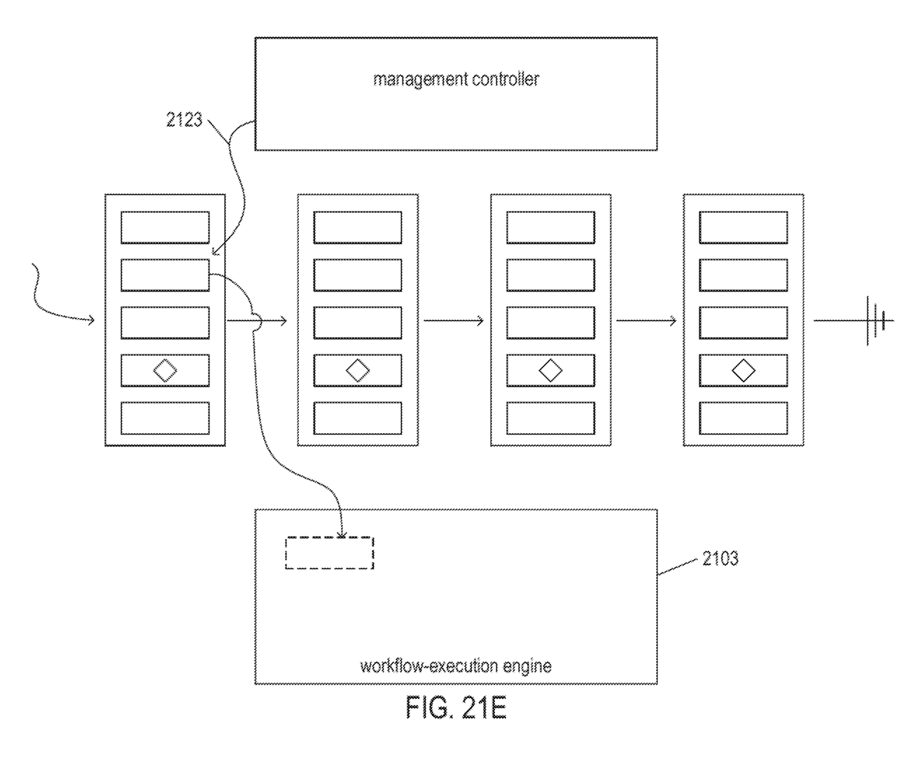

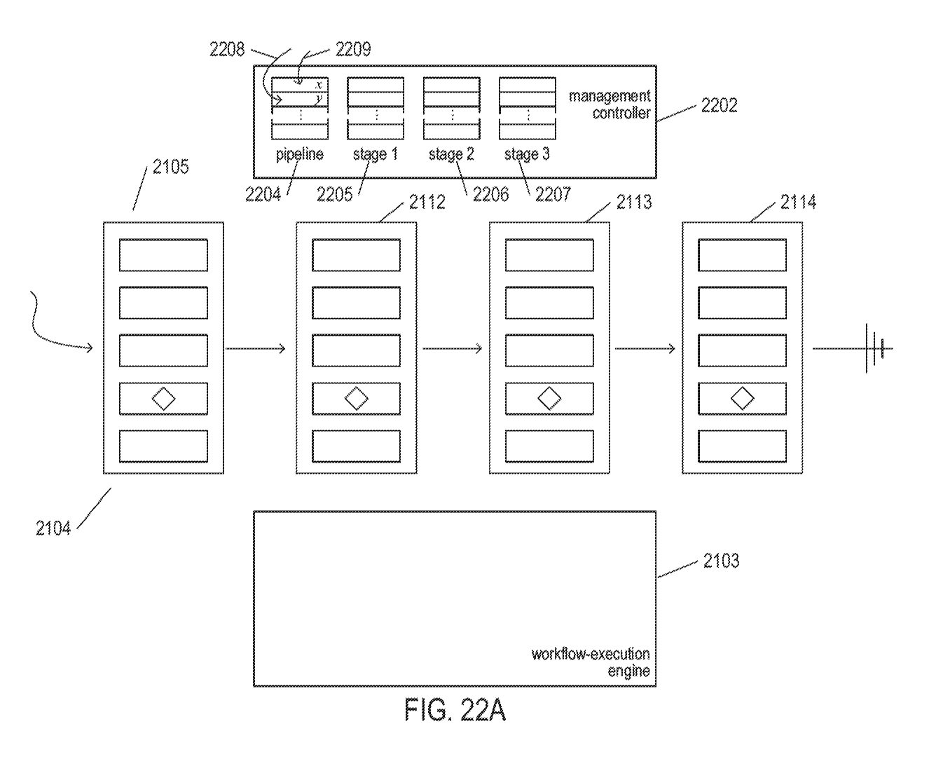

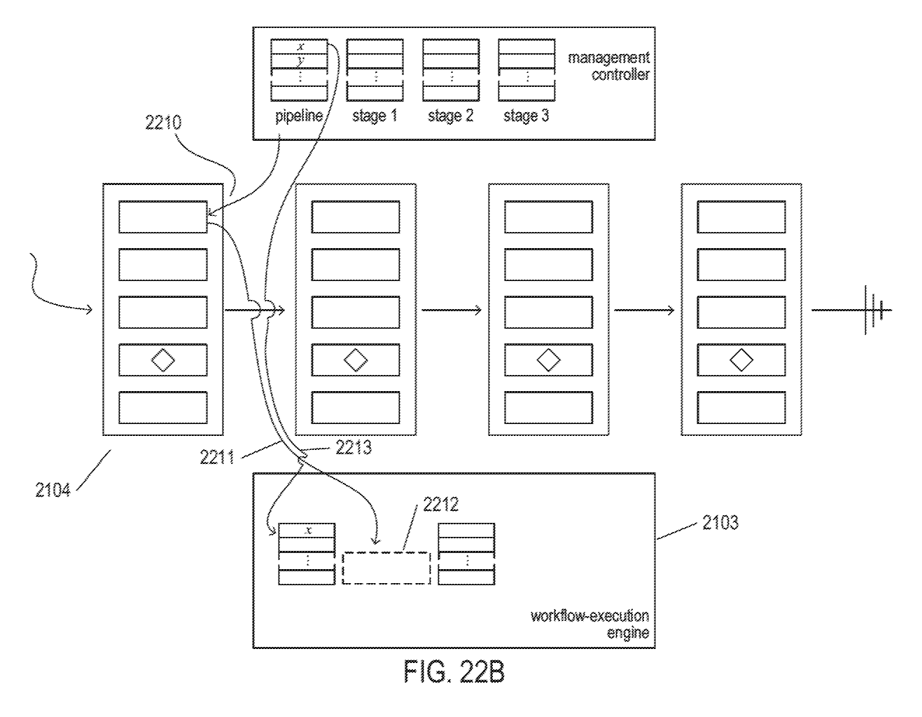

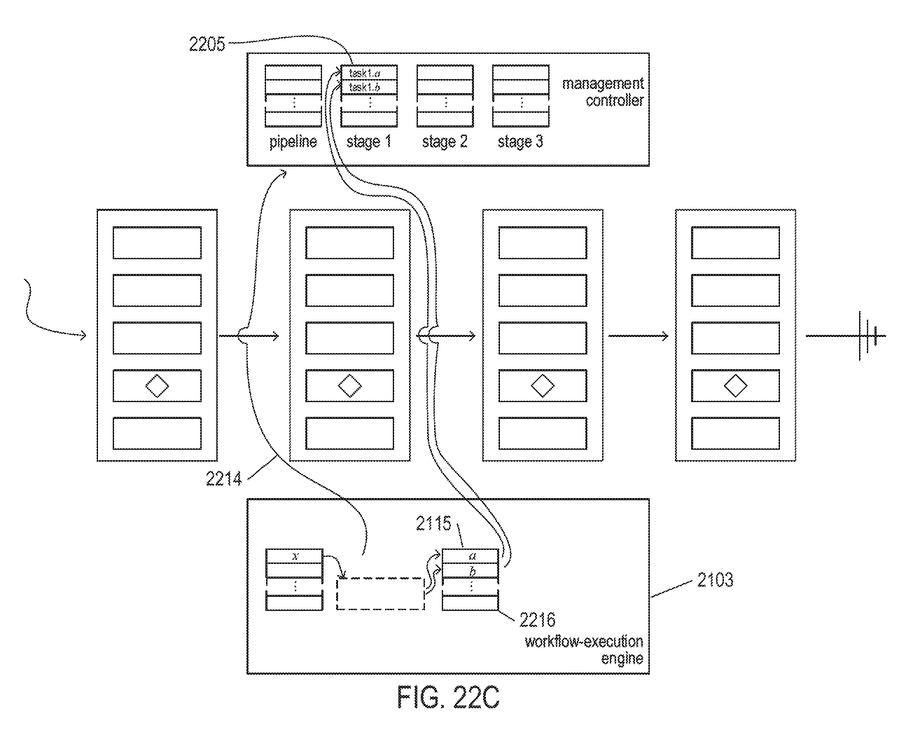

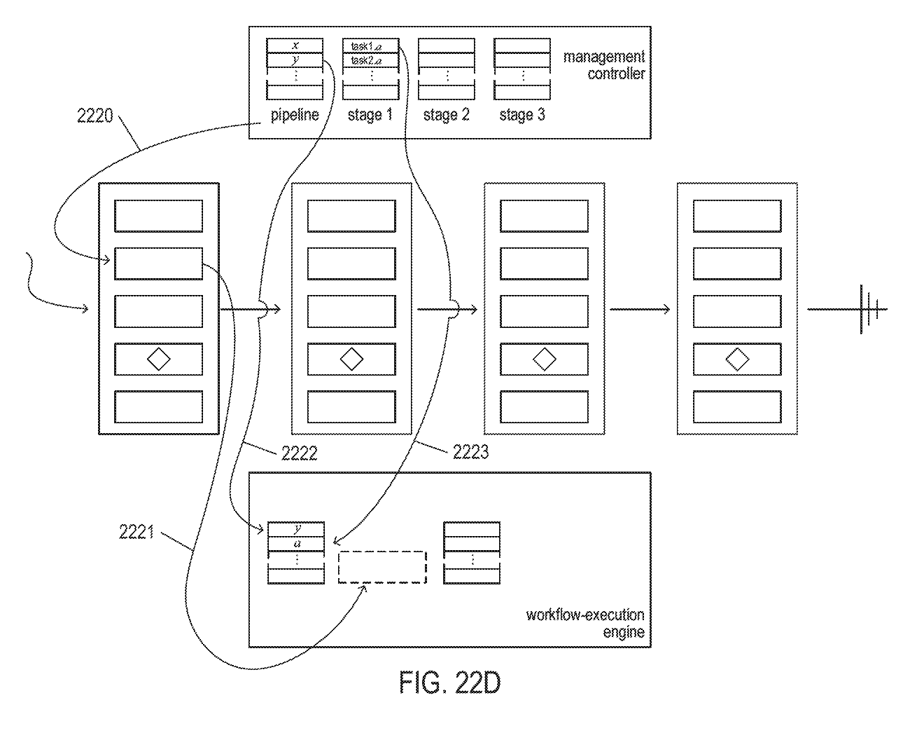

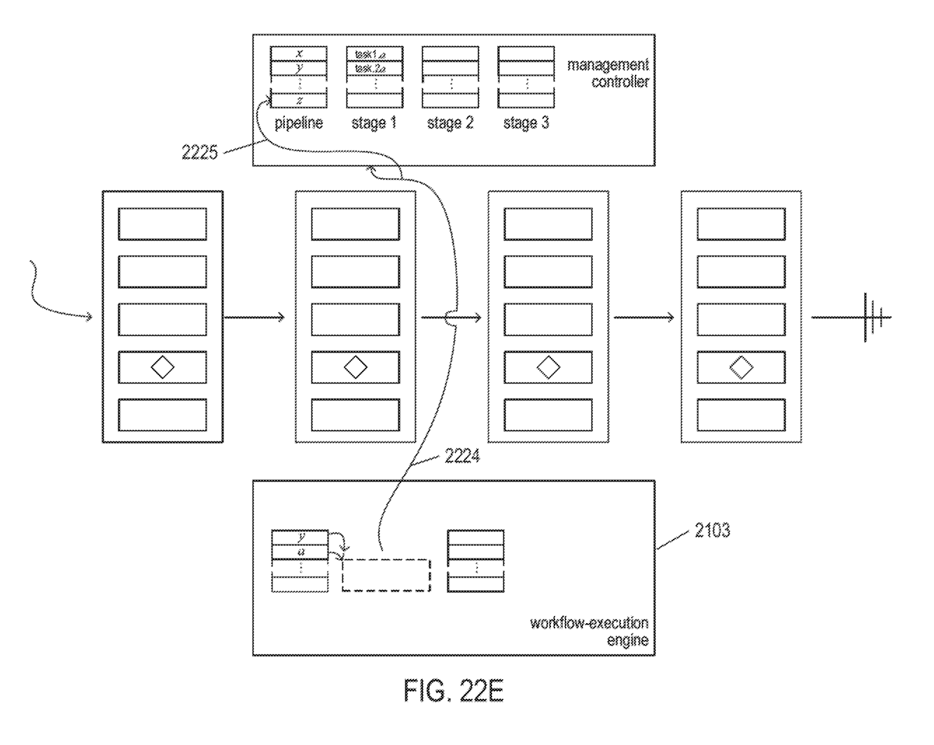

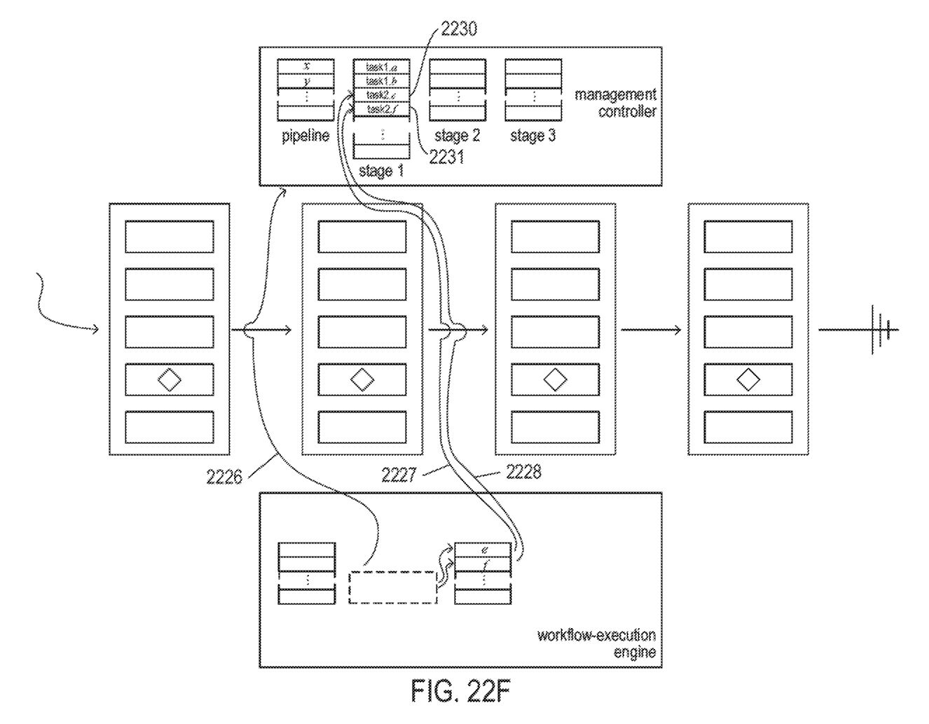

FIGS. 21A-E illustrate task execution controlled by an automated-application-release-management-subsystem management controller, subsequently referred to as a “management controller” in this document. The illustration conventions used in FIG. 21A are used for FIGS. 21B-E and are similar to the illustration conventions used in FIGS. 22A-F. These illustration conventions are next described with reference to FIG. 21 A.

In FIG. 21A, the application-release-management-pipeline execution machinery within an automated-application-release-management subsystem, discussed above with reference to FIGS. 18-20B, is shown using block-diagram illustration conventions. This application-release-management-pipeline execution machinery includes the management controller 2102 and the workflow-execution engine 2103. A four-stage pipeline 2104 is shown in the center of FIG. 21A. Each stage, including the first stage 2105, includes a number of tasks, such as tasks 2106-2110 in stage 2105. The gaiting-rule task 2109 is illustrated with a conditional-step symbol 2111. Similar illustration conventions are used for the remaining three stages 2112-2114.

As shown in FIG. 21B, in the initial steps of task execution, the management controller selects a next task for execution, as represented by curved arrow 2115 in FIG. 21B, and then forwards a reference to this task along with any input-parameter values required for task execution to the workflow-execution engine, as represented in FIG. 21B by curved arrow 2116 and the task image 2117 within the workflow-execution engine 2103.

Next, as shown in FIG. 21C, the workflow-execution engine executes the task. This execution may involve, as discussed above, storage and retrieval of data from an artifact-management subsystem 2118, various routine and function calls to external plug-in modules, routines, and subsystems 2119-2120, and various task-execution operations carried out by the workflow-execution engine 2103. During execution of the task, as discussed above, the workflow-execution engine may make callbacks to the management controller that results in information exchange in one or both directions, as represented by double-headed arrow 2121 in FIG. 21C.

As shown in FIG. 21D, when execution of the task completes, the workflow-execution engine notifies the management controller, as represented by curved-arrow 2122. The management controller carries out various task-completion operations, including, in many cases, receiving and processing output parameters output by execution of the task.

Next, as shown in FIG. 21E, the management controller selects a next task to execute, represented by curved arrow 2123 in FIG. 21E, and forwards a reference to this task to the workflow-execution engine 2103, which executes the task, as discussed above. This process continues for each task of each stage of the pipeline.

In currently available automated-application-release-management subsystems, while the management controller may furnish parameter values as inputs for task execution and may receive output parameters from tasks following completion of their execution, there is no method or logic that allows tasks to exchange parameter values among themselves during execution of a pipeline. The tasks and stages are predefined, prior to execution of the pipeline, with predefined input and output parameters.

FIGS. 22A-F illustrate the management controller to which the current document is directed. This management controller, and the automated-application-release-management subsystem in which the management controller operates, provides for information exchange between tasks of an executing pipeline.

As shown in FIG. 22A, the management controller to which the current document is directed 2202 includes parameter-value storage arrays 2204-2207 that reside in memory and that are accessible from within the execution context of the management controller. These memory-resident parameter-value arrays are maintained over the course of execution of any particular pipeline. The first array 2204 stores pipeline parameters that serve a role similar to global variables in structured programming languages. The values of these parameters are available prior to and throughout execution of each pipeline. The remaining memory-resident parameter-value arrays 2205-2207 contain parameter values output by tasks during execution of each of the first three stages 2105 and 2112-2113 of pipeline 2104. When the pipeline has a greater number or fewer stages, there are a greater number or fewer stage-specific memory-resident parameter-value arrays maintained in the execution context of the management controller. While shown as arrays in the example of FIGS. 22A-F, the parameter values may be alternatively stored in linked lists, associative parameter-value data storage, and in other types of data-storage data structures. In alternative implementations, there may be a separate memory-resident data structure for each task of each stage. In FIG. 22A, the management controller is preparing to execute pipeline 2104. The pipeline, using features described below, is specified and configured to provide for pipeline parameters that are associated with the pipeline and maintained in memory during execution of the pipeline. In FIG. 22A, the management controller initializes two of the pipeline parameters to have the values x and y, as indicated by curved arrows 2208 and 2209 in FIG. 22A.

FIG. 22B shows launching of a first task for execution by the management controller to which the current document is directed. As discussed previously, the first task is selected 2210 by the management controller and transferred to the workflow-execution engine 2103, as indicated by curved arrow 2211 and task image 2212. In addition, because the pipeline has been developed to access parameter variables, and because the first task includes a mapping or specification of the first pipeline variable as the first input parameter to the task, the management controller, as indicated by curved arrow 2212, extracts the first value from the pipeline parameter-value array and passes the parameter value as the first input value for the first task to the workflow-execution engine, as represented by curved arrow 2213.

FIG. 22C shows execution and task-execution completion for the first task. As shown in FIG. 22C, when execution of the first task is completed, the workflow-execution engine 2103 notifies the management controller of task completion, as indicated by curved arrow 2214 in FIG. 22C. The output parameters from the first task, with values a 2215 and b 2216, are retrieved by the management controller and entered into the parameter-value memory-resident array 2205 for the first stage. Note that the parameter values are stored with task specifiers, as in the example of the task-specifier/parameter value “task 1.a.” As mentioned above, in alternative implementations, there may be a separate memory-resident parameter-value array for each task of each stage, in which case the task specifiers would not be needed.

FIG. 22D shows launching of a second task by the management controller. The management controller selects the second task 2220 for execution and forwards that task to the workflow-execution engine 2221. The second task has been developed to receive, as input parameter values, the second pipeline parameter value and the first parameter value output by the previously executed task. The management controller finds the stored parameter values specified for input to the second task and furnishes these values to the workflow-execution engine, as represented by curved arrow 2222 and 2223. Values may be specified as arguments to a task-execution command, which includes a reference to the task to be executed, or may be alternatively specified, depending on the workflow-execution-engine API.

As shown in FIG. 22E, during execution of the second task, the workflow-execution engine 2103 may make a callback, as represented by curved arrow 2224, to the management controller. In the example shown in FIG. 22E, the callback involves passing a parameter value to the management controller to store as the current value of a pipeline variable, as indicated by curved arrow 2225. In other callbacks, the value of a pipeline parameter may be fetched and returned to the workflow-execution engine. Event-reporting callbacks were discussed above with reference to FIG. 20B. Thus, the values of pipeline parameters may be used as global variables for pipeline-task execution.

FIG. 22F shows execution and completion of execution of the second task. When the second task finishes executing, as indicated by curved arrow 2226 in FIG. 22F, the management controller is notified. The management controller receives, as indicated by curved arrows 2227 and 2228, the values of two output parameters from the workflow-execution controller output by the second task and stores these parameter values in entries 2230 and 2231 of the memory-resident parameter-value array 2205 with task specifiers indicating that they are output by task 2. These parameter values, along with the previously stored output parameter values from task 1, are now available for input to subsequently executed tasks of the current stage and subsequently executed stages.

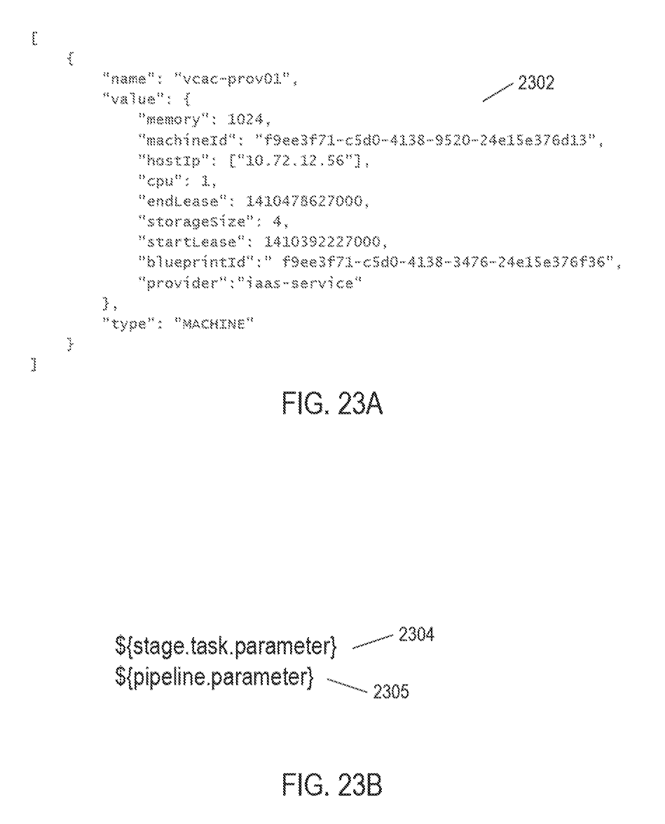

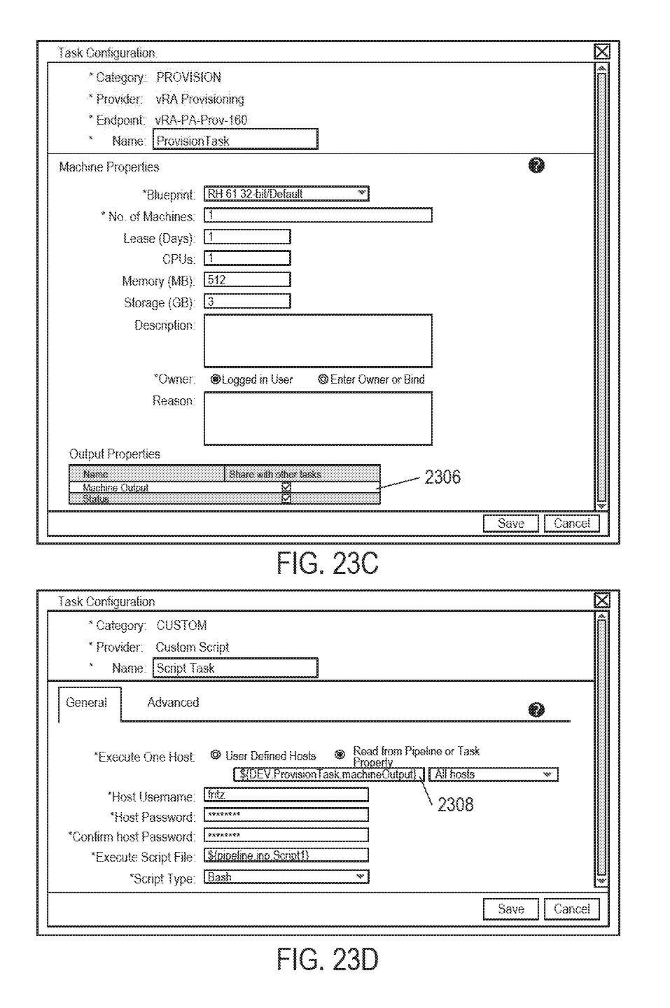

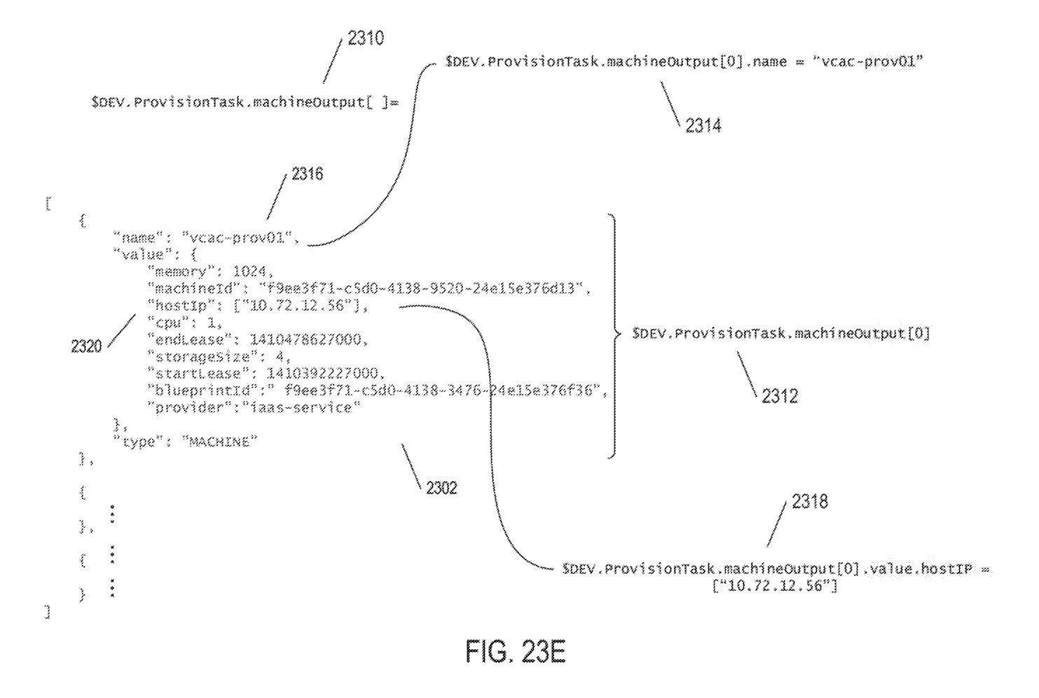

FIGS. 23A-E illustrate an example parameter, parameter-specifying subexpressions, and example specification of inter-task parameter-value exchange via the graphical user interface provided by the automated-application-release-management subsystem containing the currently disclosed management controller. FIG. 23A shows a JSON encoding of an output parameter machineOutput. This output parameter is an array of objects of type Machine, each a structure-like data type that includes a name, various parameters that describe a server, and a type indication “MACHINE.” The output parameter shown in FIG. 23A includes a single object 2302 of type Machine. The currently disclosed management controller provides flexible data typing for parameter values exchanged between tasks during pipeline execution. The management controller can parse JSON encodings, XML, and other such self-describing data types and can receive and output various different types of data-type values well known in both compiled and interpreted programming languages.

As shown in FIG. 23B, and as discussed below, during configuration of a pipeline via the graphical under interface provided by the automated-application-release-management subsystem, a parameter value can be specified as the value output by another task or as the value of a pipeline parameter. In one implementation, a dollar-sign-and-bracket notation is used to enclose a path-like specification of a particular inter-task parameter or pipeline parameter. An inter-task parameter, for example, is specified by the expression type 2304, with the contents of the braces including the specification of a stage, a task within a stage, and a particular parameter output by the task. By contrast, pipeline parameters are specified by the term “pipeline” followed by the name of the parameter, as indicated in expression 2305 in FIG. 23B.

FIG. 23C shows an input window displayed by the graphical user interface of an automated-application-release-management subsystem. In the text-entry field 2306, a pipeline definer has input text indicating that a provision task outputs a first parameter machineOutput that is an array of data objects of type “Machine.” In FIG. 23D, a graphical-user-interface input window shows configuration of a subsequent task that receives, as an input parameter, the value of parameter machineOutput that is output by the task configured in FIG. 23C, as indicated using the dollar-sign-and-brace notation 2308.

FIG. 23E shows how the JSON-encoded output parameter machineOutput generated by the provision task, in part configured through the input window displayed by the graphical user interface that is shown in FIG. 23C and discussed above, can be accessed in a subsequent task. The output parameter machineOutput is a JSON array containing one or more objects of type Machine, as discussed above. The entire array can be referenced, as shown by reference 2310 in FIG. 23E, as “$DEV.ProvisionTask.machineOutput.” However, individual objects of type Machine, and fields and objects within individual objects of type Machine, can be also be referenced. For example, the first object of type Machine in the array, previously shown as the single object 2303 of type Machine in FIG. 23A, can be accessed using the reference (2312 in FIG. 23E) “$DEV.ProvisionTask.machineOutput[0].” The name field 2316 of this first object, having the value “vcac-prov01,” can be accessed by the reference (2314 in FIG. 23E) as “$DEV.ProvisionTask.machineOutput[0].name.” The hostIP field of the value field of this first object 2320 can be accessed by the reference (2318 in FIG. 23E) “$DEV.ProvisionTask.machineOutput[0].value.hostIP.”

The parameter binding between tasks is agnostic with respect to the type of encoding, allowing parameter values to be encoded in Extensible Markup Language (“XML”), JSON, YAML, and other such standard encoding formats. The input and output parameters have data types, such as the data type “array of objects of type Machine” used in the example of FIGS. 23A-E. As can be seen in the example of FIGS. 23A-E, the data types are essentially arbitrarily complex and, in many cases, are self-describing or at least partially self-describing, to facilitate exchange between pipeline tasks and external plug-ins. When a type mismatch between a parameter output by a first task and input by a second task is detected, binding may nonetheless be achieved by data-type transformations, in which field, objects, and values may be cast from one type to another or from one encoding to another encoding, in order to facilitate data exchange between tasks and between tasks and plug-ins.

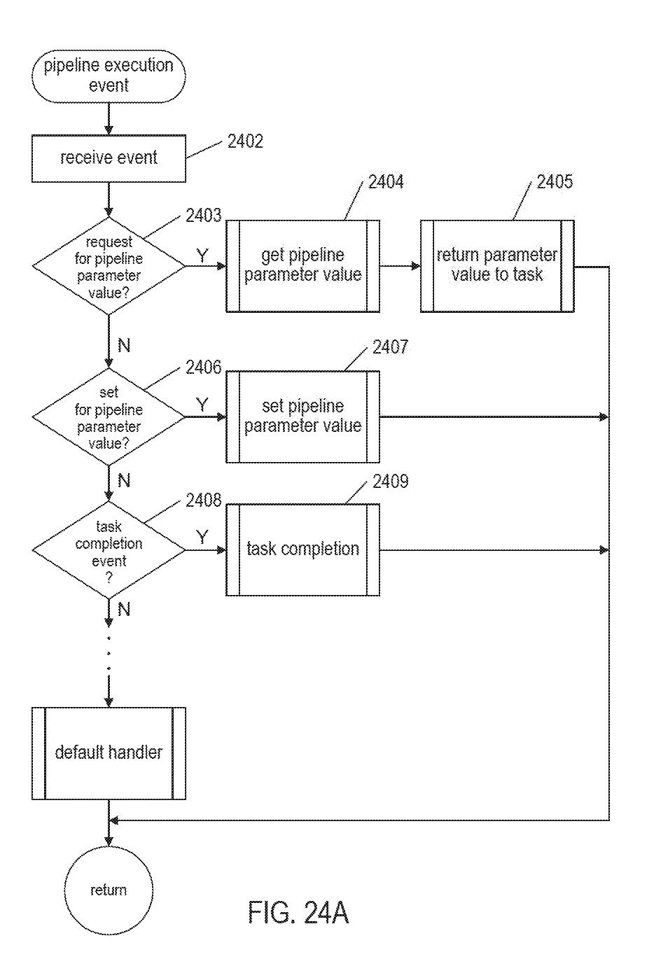

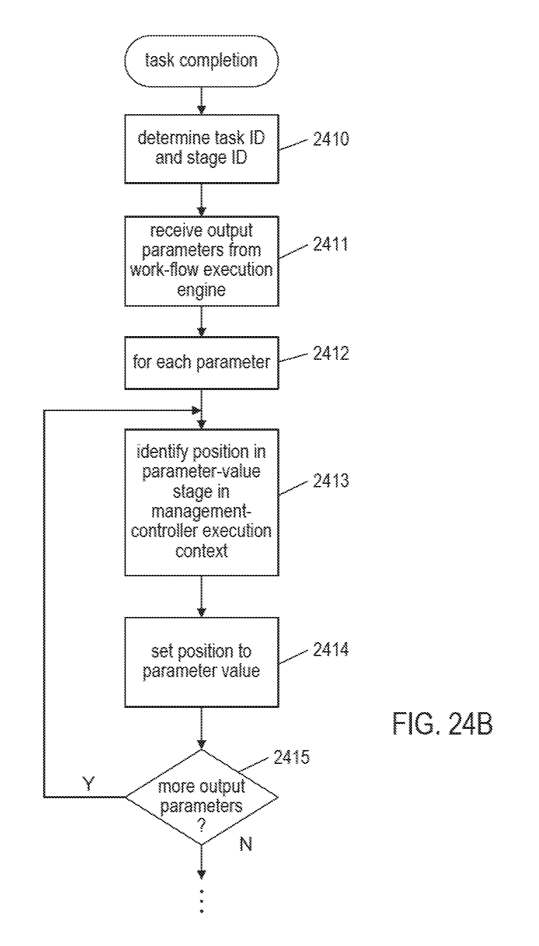

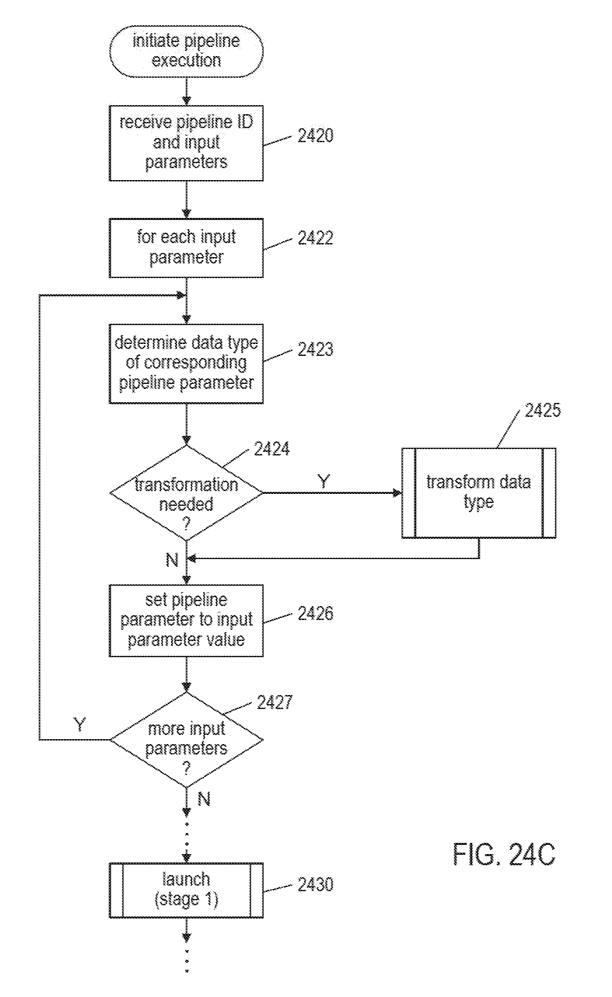

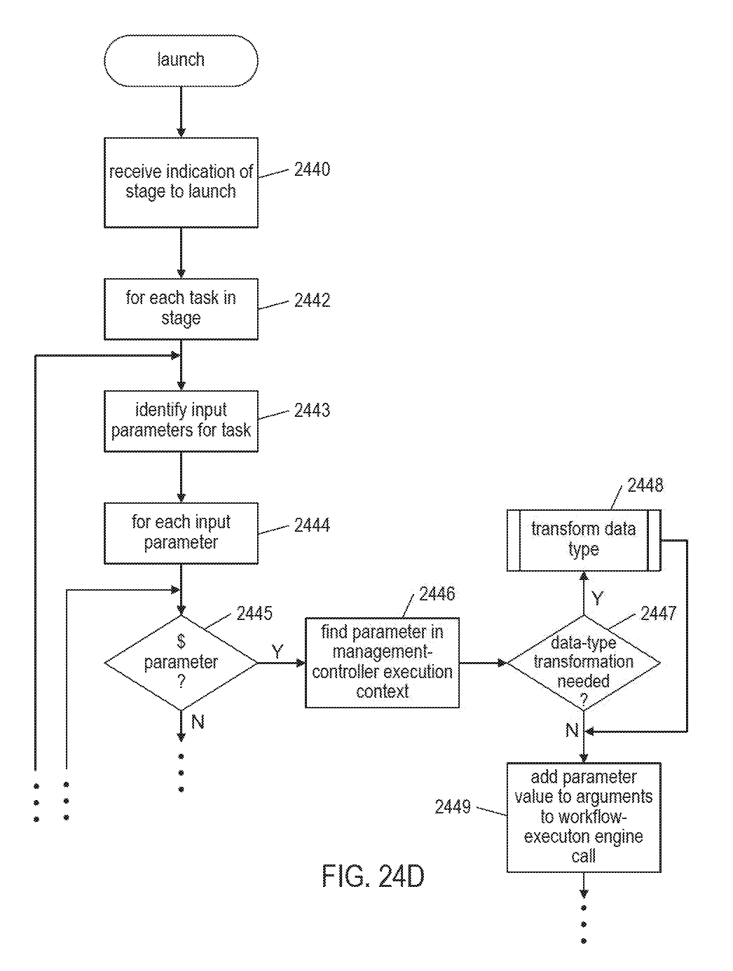

FIGS. 24A-D provide extracts of control-flow diagrams to indicate how, in one implementation, the management controller provides for inter-task information exchange. FIG. 24A shows a partial implementation of the pipeline-execution-event routine called in step 2028 of FIG. 20B. In step 2402, the pipeline-execution-event routine receives an indication of the pipeline-execution event that needs to be handled. When the event is a request, by the workflow-execution engine, for a parameter value via a callback, as determined in step 2403, then, in step 2404, the management controller accesses the specified pipeline parameter value in the memory-resident pipeline-parameter-value array and returns that value to the workflow-execution engine for task execution, in step 2406. Otherwise, when the event is a request to set a pipeline-parameter value via a callback by the workflow-execution engine, as determined in step 2406, then the management controller sets the specified pipeline parameter to the indicated value in step 2407. When the event is a task-completion event, as determined in step 2408, then a task-completion handler is called in step 2409.

FIG. 24B shows a partial implementation of the task-completion handler called in step 2409 of FIG. 24A. In step 2410, the task-completion handler determines the identifier of the currently executing task and stage that includes the currently executing task. In step 2411, the task-completion handler receives the output parameters from the workflow-execution engine. Then, in the for-loop of steps 2412-2415, the task-completion handler considers each output parameter returned by the task, execution of which just completed. In step 2413, the task-completion handler identifies the position in which to place the returned parameter value within a memory-resident parameter-value array in the management-controller execution context. Then, in step 2414, the value at that position is set to the returned parameter value.

FIG. 24C shows a partial implementation of the initiate-pipeline-execution handler called in step 2024 in FIG. 20B. In step 2420, the initiate-pipeline-execution handler receives a pipeline ID and input parameters. In the for-loop of steps 2422-2427, the handler considers each received input parameter. In step 2423, the handler determines the data type of the corresponding pipeline parameter. In step 2424, the handler determines whether a data-type transformation is needed to transform the input parameter to a stored pipeline-parameter value. When a transformation is needed, a transformation-data-type routine is called in step 2425. In step 2426, the handler sets the pipeline parameter corresponding to the input parameter to the input parameter value. In a subsequent step 2430, the initiate-pipeline-execution handler launches the first stage of a pipeline.

FIG. 24D shows a partial implementation of the launch routine called in step 2430 of FIG. 24C. In step 2440, the launch routine receives an indication of a stage for which execution needs to be initiated. In the for-loop of steps 2442-2449, each task in the stage is launched. For the currently considered task, the launch routine identifies the input parameters for the task in step 2443. For each input parameter, in an inner for-loop comprising steps 2444-2449, each of the input parameters is considered. When the input parameter is an inter-task parameter, as determined in step 2445, then, in step 2446, the launch routine finds the parameter in the management-controller execution context. When a data type transformation is needed for the parameter, as determined in step 2447, the stored parameter value is transformed, in step 2448. In step 2449, the parameter value is added as an argument to a workflow-execution-engine call to launch execution of the currently considered task. In steps not shown in FIG. 24D, the launch routine waits for execution to continue before launching execution of a subsequent task.

Although the present invention has been described in terms of particular embodiments, it is not intended that the invention be limited to these embodiments. Modifications within the spirit of the invention will be apparent to those skilled in the art. For example, any of many different implementation and design parameters, including choice of operating system, virtualization layer, hardware platform, programming language, modular organization, control structures, data structures, and other such design and implementation parameters can be varied to generate a variety of alternative implementations of the current disclosed automated-application-release-management subsystem and management controller. Various different inter-task and pipeline parameter notations can be employed for specifying inter-task and pipeline parameter when developing and configuring tasks and stages through the user interface provided by the automated-application-release-management subsystem. As mentioned above, inter-task and pipeline parameter values maybe be stored in various different types of data-storage structures in one or more memories within a computer-system platform for an automated-application-release-management subsystem.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A workflow-based cloud-management system incorporated within a cloud-computing facility having multiple servers, data-storage devices, and one or more internal networks, the workflow-based cloud-management system comprising:
an infrastructure-management-and-administration subsystem;
a workflow-execution engine;
an automated-application-deployment subsystem; and
an automated-application-release-management subsystem that executes application-release-management pipelines that each comprises one or more stages, each having one of more tasks including one or more tasks that, when executed, each receives, as one or more input parameter values, parameter values output by one or more previously executed tasks.

2. The workflow-based cloud-management system of claim 1 wherein the automated-application-release-management subsystem comprises:
a dashboard user interface;
a management controller;
an interface to the workflow-execution engine; and
an artifact-storage-and-management subsystem.

3. The workflow-based cloud-management system of claim 2 wherein the automated-application-release-management subsystem and the infrastructure-management-and-administration subsystem include control logic at least partially implemented as workflows that are executed by the workflow-execution-engine subsystem.

4. The workflow-based cloud-management system of claim 2 wherein the application-release-management pipelines executed by the automated-application-release-management subsystem further include one or more tasks that, during execution, each receives, as one or more input parameter values, one or more pipeline parameter values associated with the application-release-management pipeline in which the task is incorporated.

5. The workflow-based cloud-management system of claim 2 where the application-release-management pipelines executed by the automated-application-release-management subsystem further include one or more tasks that, during execution, each accesses one or more pipeline parameters associated with the application-release-management pipeline in which the task is incorporated to store a new value in, or retrieve a previously stored value from, each oaf the one or more pipeline parameters.

6. The workflow-based cloud-management system of claim 2 wherein the management controller stores, in memory accessible from within the execution context of the management controller, one or more pipeline parameter values and one or more output parameter values, each generated by execution of a task incorporated within an application-release-management pipeline, execution of which is currently controlled by the management controller.

7. The workflow-based cloud-management system of claim 6 wherein tasks of application-release-management pipelines are developed and configured, through the dashboard user interface, to receive input parameter values, access pipeline parameters, and output parameters values.

8. The workflow-based cloud-management system of claim 7 wherein an input parameter is specified through the dashboard user interface as one of:
an input parameter with a value provided by the management controller to the workflow-execution engine;
an inter-task input parameter with a value generated by a previously executed task that is retrieved from memory by the management controller and provided by the management controller to the workflow-execution engine; and
a pipeline parameter with a value generated by one of the management controller and a previously executed task that is retrieved from memory by the management controller and provided by the management controller to the workflow-execution engine.

9. The workflow-based cloud-management system of claim 7 wherein an inter-task input parameter is specified using a notation that, includes:
one more symbols that identify the parameter as one of an inter-task parameter and a pipeline parameter;
one or more symbols that represent a stage/task path; and
one or more symbols that comprise a parameter name.

10. The workflow-based cloud-management system of claim 9
wherein the one or more symbols that identify the parameter as one of an inter-task parameter and a pipeline parameter is the symbol “$;” and
wherein the one or more symbols that represent a stage/task path comprises a stage name, a first period, a task name, and a second period.

11. The workflow-based cloud-management system of claim 7 wherein a pipeline parameter is specified using a notation that includes:
one or more symbols that identify the parameter as one of an inter-task parameter and a pipeline parameter;
one or more symbols that indicate that the parameter is a pipeline parameter; and
one or more symbols that comprise a parameter name.

12. The workflow-based cloud-management system of claim 9
wherein the one or more symbols that identify the parameter as one of an inter-task parameter and a pipeline parameter is the symbol “$;” and
wherein the one or more symbols that indicate that the parameter is a pipeline parameter comprises the word “pipeline”.

13. The workflow-based cloud-management system of claim 7 wherein a pipeline parameter is specified through the dashboard user interface as a global parameter, the value of which is set by one of the management controller, a previously executed task, and a currently executing task.

14. The workflow-based cloud-management system of claim 1 wherein a first pipeline task outputs the value of an output parameter of a first type that is automatically transformed from the first type to a second type for input to a second pipeline task that receives input values of an input parameter of the second type.

15. A method that provides one or more inter-task parameters for a task incorporated in an application-release-management pipeline executed by an automated-application-release-management-subsystem component of a workflow-based cloud-management system that is incorporated within a cloud-computing facility having multiple servers, data-storage devices, and one or more internal networks, the method comprising:
developing and configuring the task to receive, as one or more input-parameter values, one or more stored values, each output by a previously executed task; and
launching, by a management controller, execution of the task by supplying a reference to the task and the one or more stored values to a task-execution engine.

16. The method of claim 15 wherein the workflow-based cloud-management system comprises:
infrastructure-management-and-administration subsystem;
a workflow-execution engine;
an automated-application-deployment subsystem; and
the automated-application-release-management subsystem that executes application-release-management pipelines that each comprises one or more stages, each having one of more tasks including one or more tasks that, when executed, each receives, as one or more input parameter values, parameter values output by one or mote previously executed tasks.

17. The method of claim 15 wherein the automated-application-release-management subsystem comprises:
a dashboard user interface;
the management controller;
an interface to the workflow-execution engine; and
an artifact-storage-and-management subsystem.

18. The method of claim 15 wherein the application-release-management pipelines executed by the automated-application-release-management subsystem further include one or more tasks that, diming execution, each receives, as one or more input parameter values, one or more pipeline parameter values associated with the application-release-management pipeline in which the task is incorporated.

19. The workflow-based cloud-management system of claim 18 wherein the application-release-management pipelines executed by the automated-application-release-management subsystem further include one or more tasks that, during execution each accesses one or more pipeline parameters associated with the application-release-management pipeline in which the task is incorporated to store a new value in, or retrieve a previously stored value from each of the one or more pipeline parameters.

20. The workflow-based cloud-management system of claim 19 wherein the management controller stores, in memory accessible from within the execution context of the management controller, one or more pipeline parameter values and one or more output parameter values, each generated by execution of a task incorporated within an application-release-management pipeline, execution of which is currently controlled by the management controller.

21. Computer instructions, stored within one or more physical data-storage devices, that, when executed on one or more processors within a cloud-computing facility having multiple servers, data-storage devices, and one or more internal networks, control the cloud-computing facility to provide one or more inter-task parameters for a task incorporated in an application-release-management pipeline executed by an automated-application-release-management-subsystem component of a workflow-based cloud-management system that is incorporated within the cloud-computing facility by:
developing and configuring the task to receive, as one or more input-parameter values, one or more stored values, each output by a previously executed task; and
launching, by a management controller, execution of the task by supplying a reference to the task and the one or more stored values to a task-execution engine.
